(19) United States
(12) Patent Application Publication
(10) Pub. No.: US 2006/0077242 A1
(43) Pub. Date: Apr. 13, 2006

(54) Printer and printing control method

(75) Inventors: Tetsuji Takeishi, Nagano (JP); Hisataka Kugimachi, Nagano (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/241,100

(22) Filed: Sep. 29, 2005

(30) Foreign Application Priority Data
Sep. 29, 2004 (JP) P2004-283642
Sep. 30, 2004 (JP) P2004-288703
Sep. 30, 2004 (JP) P2004-288704

(51) Int. Cl. B41J 2/01

(52) U.S. Cl. 347/101

(57) ABSTRACT

A printing device has a first part and a second part and prints an image on a medium adapted to be transported from the first part to the second part in a transport direction and having a notch disposed at a back end portion in the transport direction. A printing head is disposed between the first part and the second part and is adapted to eject ink to the medium. A first driver is operable to drive one of a pair of rollers adapted to nip the medium to form a nip portion therebetween so that the rollers transport the medium from the first part to the second part in the transport direction. A second driver is operable to drive the printing head so that the printing head ejects the ink to the medium. An anticipator anticipates a location of the back and portion. A controller is operable to control the second driver so as to cause the printing head not to eject the ink in association with the location anticipated by the anticipator.

### BACKGROUND OF THE INVENTION

The present invention relates to a printer and a printing control method.

In printers including an inkjet one, types capable of performing a variety of printing are prevailing. Among such types of printers, there exists a type capable of performing so-called four-side margin-less printing. Also, such types of printers normally has a transport roller pair and a paper discharge roller pair, which each include a drive roller and a driven roller, wherein a printing object is transported nipped between both rollers of each of the roller pairs. In this configuration, normally, at least one of the drive and driven rollers of each of the roller pairs is connected to a spring, and a biasing force is applied by the springs to the printing object.

In the meantime, in performing the margin-less printing on a thick printing object, the thick printing object is often affected by the phenomenon of so-called “kicking”. This “kicking” occurs as the rear end of the printing object reaches between a transport roller pair. That is, out of the transport roller pair, a driven roller is connected to a spring. Consequently, when reaching between the transport roller pair, the rear end of the thick printing object is biased by the spring toward a discharge side, thus unpredictably increasing the speed of transport of the printing object. This is the phenomenon called “kicking”, and there arises the problem in which the occurrence of this phenomenon results in nonuniform printing on the printing object, thus preventing proper printing.

Thereupon, as technology for securing paper feed accuracy even in the vicinity of the rear end of the printing object in order to solve such a problem, there is technology disclosed in JP-A-2002-96512. According to this technology disclosed in JP-A-2002-96512, when the rear end of the printing object reaches a predetermined region, a current to be conducted to a motor is controlled, so that a hold current that increases a current value applied to the motor is allowed to flow through the motor, thus imparting the motor with a torque sufficient to resist “kicking”. Besides, disclosed in JP-A-2004-123313 is technology for correcting a transport error caused when the printing object is transported by the transport roller pair and the paper discharge roller pair.

In the meantime, as the thick printing object, there is a kind called photo stand paper (photo cardboard). In the photo stand paper, there exist notches obtained by cutting off both ends of the photo stand paper in one diagonal direction thereof. A user processes the photo stand paper, for example, by folding and thereby can readily form a support flap, which enables a printed surface to stand on end.

Meanwhile, to print such photo stand paper, desirably, “kicking” control disclosed in Patent Document 1 can be exerted. That is, preferably, the rear end of paper is detected using a paper detector, and a hold current is conducted to a motor based on the detection, thus imparting the motor with a hold force sufficient to be able to resist a spring force even when the rear end of the paper reaches between both rollers.

However, the paper detector is disposed to one side on which a cleaning mechanism exists and which is used as a reference in a main scan direction to set the printing objects having a plurality of kinds of sizes. Therefore, the existence of the notches in the photo stand paper makes it difficult to detect the rear end side of the photo stand paper. That is, to prevent the aforesaid “kicking”, it is necessary to accurately detect the rear end side of the photo stand paper. However, the existence of the notches prevents the rear end of the photo stand paper from being accurately detected using the paper detector.

Besides, if, due to the existence of the notches, it is determined that no photo stand paper exists, there is the possibility of damaging a printhead. That is, it is determined that no photo stand paper exists although the thickness photo stand paper actually exists on a platen. And, for example, to perform a cleaning operation, by operation of a gap adjusting mechanism and the like, the gap between the printhead and the platen is set to respond to the state in which no thick photo stand paper exists. And, in this state, upon movement of the carriage, the printhead sometimes comes into contact with the photo stand paper, thus causing the damage of the printhead.

Here, to prevent misidentification of the kind of paper and contact of the carriage which are involved in the existence of the notches, it is only necessary to adopt the configuration in which the setting reference exists not on the side in the main scan direction on which the cleaning mechanism exist, but on the side opposite thereto. However, in this case, it becomes more difficult to accurately detect the rear end of the photo stand paper. Besides, in the current printer, the paper detector is disposed on the side in the main scan direction on which the cleaning mechanism exists, so that it is difficult to change a layout of the paper detector in the main scan direction, because of the relationship with the other configurations.

As above, in the present situation, the rear end side of the photo stand paper cannot be accurately detected. Therefore, to print the photo stand paper, the so-called “kicking” cannot be prevented from occurring, thus making is impossible to perform the margin-less printing and the like.

Additionally, as aforesaid, because of the structure of the printer, the rear end of the photo stand paper cannot be accurately detected using the paper detector, so that the problem of contaminating the platen occurs concomitantly. That is, as aforesaid, the setting reference for the photo stand paper is set on the side opposite the side on which the paper detector is disposed, so that an ink droplet ejection end position cannot be set. As a result thereof, in some cases, ink droplets are ejected wit the photo stand paper already discharged, thus contaminating the top surface of the platen.

Additionally, in the transport roller pair and the paper discharge roller pair, normally, the drive and driven rollers thereof are not uniform and vary in circumferential outer diameter. Therefore, in transporting the photo stand paper, a difference in transport amount increases cumulatively as the transport proceeds, thus causing a deterioration in print quality. Furthermore, in transporting the photo stand paper or the like, when there is a difference in transport amount between the transport roller pair and the paper discharge roller pair, it is more difficult to improve print quality. Here, a transport error of a general printing object can be resolved by using the technology disclosed in Patent Document 1. However, as aforesaid, because of the structure of the printer, the rear end of the photo stand paper cannot be accurately detected by the paper detector. Therefore, when the printing object comes off the transport roller pair and then becomes ready to be transported by only the paper discharge roller pair, the amount transported by the paper discharge roller pair cannot be accurately corrected.

### SUMMARY

The invention has been made in view of the above circumstances, and advantages thereof are to provide a printer and a printing control method in which, to print a printing object provided with a notch, ejection of ink droplets can be properly controlled to prevent contamination of the top surface of a guide member, to provide a printer and a drive control method that can prevent “kicking” from occurring when printing is performed on a printing object provided with a notch, and to provide a printer and a drive control method that that appropriately correct the driving of a transport roller pair and the driving of a paper discharge roller pair when printing a printing object provided with a notch, thus enabling an improvement in print quality.

According to the present invention there is provided:

a printing device having a first part and a second part and printing an image on a medium adapted to be transported from the first part to the second part in a transport direction and having a notch disposed at a back end portion in the transport direction, the printing device comprising:

a printing head disposed between the first part and the second part and adapted to eject ink to the medium;

a first driver operable to drive one of a pair of rollers adapted to nip the medium to form a nip portion therebetween so that the rollers transport the medium from the first part to the second part in the transport direction;

a second driver operable to drive the printing head so that the printing head ejects the ink to the medium;

an anticipator anticipating a location of the back end portion; and

a controller operable to control the second driver so as to cause the printing head not to eject the ink in association with the location anticipated by the anticipator.

According to an aspect of the invention, the anticipator anticipates the back end portion of an amount of the medium transported which corresponds to the notch, and based on the anticipated location, the controller stops the driving of the second driver when the medium reaches the transport amount up to the back end portion. Thereby, the controller controls ejection of ink from the ejection element of the printing head. By so doing, the back end portion of the transport amount can be anticipated in response to the notch, and ejection of ink can be stopped based on the anticipation. Consequently, when the back end portion is set, for example, in a portion where is exposed a sliding portion such as a platen on which the medium is placed/slid, contamination with ink can be prevented. Therefore, the underside of the medium to be transported next is prevented from being contaminated.

According to the present invention there is provided:

a printing device having a first part and a second part and printing an image on a medium adapted to be transported from the first part to the second part in a transport direction and having a first notch disposed at a back end portion in the transport direction, the printing device comprising:

a guide member comprising:
a sliding portion adapted to be brought in contact with the medium and guiding the medium in the transport direction; and
a non-sliding portion including a concave portion;

a printing head disposed between the first part and the second part and having a ejecting element extending in the transport direction and adapted to cause the ejecting element to eject ink to the medium, a back section of the ejecting element without facing the sliding member;

a first driver operable to drive a pair of rollers adapted to nip the medium to form a nip portion therebetween so that the rollers transport the medium from the first part to the second part;

a second driver operable to drive the printing head so that the ejecting element ejects the ink to the medium;

a first acquirer operable to move in a widthwise direction perpendicular to the transport direction of the medium so as to acquire one of present information and absent information of the medium in the widthwise direction;

a fixer fixing a reference point at which the absent information turns to the present information;

a storage storing first predetermined drive-transport information for the first driver from a predetermined reference point corresponding to the reference point to the back end portion;

a second acquirer acquiring drive-transport information of the first driver in association with the present information;

a third acquirer acquiring first correspondence information between the nip portion and the back end portion in association with the drive-transport information and the first predetermined drive-transport information; and

a controller operable to control the second driver so as to cause the ejecting element not to eject the ink in association with the first correspondence information.

According to an aspect of the invention, the first acquirer acquirers the reference point while the medium is being slid on the sliding section of the guide member by the driving of the first driver. And, the fixer determines whether this reference point is reached or not. Besides, the third acquirer determines whether or not the roller pair has reached the back end portion of the amount of the medium transported. And, when it is determined that the back end portion is reached, the controller stops the driving of the second driver and stops ejection of ink from the ejection element of the printing head. Thereby, even when printing is performed on the medium provided with the notch, ink can be configured not to be ejected when the transport amount up to the back end portion is reached. Consequently, for example, when the back end portion is set in the portion where is exposed the sliding portion such as the platen on which the printing object is placed/slid, contamination with ink can be prevented. Therefore, the underside of the medium to be transported next is prevented from being contaminated.

The printing device according to the invention may have the following structure in addition to the device described above. More specifically, the back end portion of the medium is interposed between the ejecting element and the sliding portion in an ink ejecting direction, and the back section of the ejecting element faces the non-sliding portion in the ink ejecting direction.

According to an aspect of the invention, even when the back end portion of the amount of the medium transported is reached, the sliding portion is not exposed as being covered with the medium in the ink ejecting direction. On the contrary, the non-sliding portion is not covered with the medium. Therefore, even when ink is ejected from the ejection element, the sliding portion is prevented from being contaminated with ink since it is covered with the medium in the ink ejecting direction. Besides, ink that does not fall on the medium is dropped into the non-sliding portion.

The printing device according to the invention may have the following structure in addition to the device described above. More specifically, the back end portion of the medium is interposed between the ejecting element and the guide member in an ink ejecting direction.

According to an aspect of the invention, even when the back end portion of the amount of the medium transported is reached, the guide member is not exposed as being covered with the medium in the ink ejecting direction. Therefore, even when ink is ejected from the ejection element, the guide member is prevented from being contaminated with ink in the ink djecting direction.

The printing device according to the invention may have the following structure in addition to the device described above. More specifically, the medium has a second notch disposed at a front end portion in the transport direction and is diagonal to the first notch, the storage stores second predetermined drive-transport information for the first driver from a predetermined reference point corresponding to the reference point to a first switching point disposed between the reference point and the first notch, the third acquirer acquires second correspondence information between the nip portion and the first switching point in association with the drive-transport information and the second predetermined drive-transport information; and the controller is operable to control the first driver in association with the second correspondence information so that first driving speed of the first driver before the first switching point corresponds to the nip portion is larger than second driving speed of the first driver after the first switching point corresponds to the nip portion.

According to an aspect of the invention, no matter which lengthwise side of the medium, the medium is fed from, the two notches are positioned on the paper feed side and on the paper discharge side, respectively. Besides, when the third acquirer determines that the medium is transported to the switching point, the controller reduces the drive speed after the switching point is passed as compared with the drive speed from the reference point to the switching point. Therefore, this can prevent “kicking” of the medium by an elastic member from occurring in the first notch of the medium.

The printing device according to the invention may have the following structure in addition to the device described above. More specifically, the storage stores third predetermined drive-transport information from a predetermined reference point corresponding to the reference point to a second switching point disposed between the first notch and a back edge portion of the medium in the transport direction, the third acquirer acquires third correspondence information between the nip portion and the second switching point in association with the drive-transport information and the third predetermined drive-transport information; and the controller is operable to control the first driver in association with the third correspondence information so that third driving speed of the first driver before the second switching point corresponds to the nip portion is smaller than fourth driving speed of the first driver after the second switching point corresponds to the nip portion.

According to an aspect of the invention, when the roller pair passes the first notch, the drive speed of the transport drive source increases, thus enabling an increase in discharge speed. The printing device according to the invention may have the following structure in addition to the device described above. More specifically, the printing device further comprises a carriage retaining the printing head and the first acquirer.

According to an aspect of the invention, when the carriage is moved in the main scan direction to execute printing on the medium by ejecting ink from the ejection element, widthwise detection of the medium by the first acquirer is performed simultaneously with the execution of printing. Therefore, it is determined whether or not the medium exists in the widthwise direction. Thereby, it is determined whether or not the notches exist in the widthwise direction.

According to the present invention there is provided:

a control method of printing an image on a medium, transported from a first part to a second part in a transport direction and having a notch disposed at a back end portion in the transport direction, by a printing device comprising: a printing head disposed between the first part and the second part and having a ejecting element extending in the transport direction and adapted to cause the ejecting element to eject ink to the medium; a first driver operable to drive a pair of rollers adapted to nip the medium to form a nip portion therebetween so that the rollers transport the medium from the first part to the second part in the transport direction; a second driver operable to drive the printing head so that the ejecting element ejects the ink to the medium; and a storage storing predetermined drive-transport information for the first driver from a predetermined reference point to the back end portion, the control method comprising:

transporting the medium from the first part to the second part in the transporting direction;

acquiring one of present information and absent information of the medium in a widthwise direction perpendicular to the transport direction of the medium;

fixing a reference point at which the absent information turns to the present information, the reference point corresponding to the predetermined reference point;

acquiring drive-transport information of the first driver in association with the present information;

acquiring correspondence information between the nip portion and the back end portion in association with the drive-transport information and the predetermined drive-transport information; and

controlling the second driver so as to cause the ejecting element not to eject the ink in association with the correspondence information.

According to an aspect of the invention, in a transport step, the roller pair is used to perform the transport operation of transporting the medium. And, in a detection step, the first acquirer moves in the widthwise direction, thereby detecting the presence/absence of the medium in the widthwise direction. Besides, in a reference point determination step, based on the information of the presence/absence in the widthwise direction, it is determined whether the reference point at which the presence/absence of the amount of the printing object transported changes is detected or not. Furthermore, in a transport amount determination step, a transport amount from the reference point to the detection region is counted, thus determining whether or not the medium has reached a transport amount responsive to transport amount information. Besides, in a head drive stop step, when it is determined that the back end of the amount of the medium transported is reached, the driving of the second driver is stopped to stop ejection of ink from the ejection element.

By so doing, even when printing is performed on the medium provided with the first and second notches, ink can be configured not to be ejected when the transport amount up to the back end portion is reached. Consequently, for example, when the back end portion is set in the portion where is exposed the sliding portion such as the platen on which the medium is placed/slid, contamination with ink can be prevented. Therefore, the underside of the medium to be transported next is prevented from being contaminated.

According to the present invention there is provided:

a printing device having a first part and a second part and printing an image on a medium adapted to be transported from the first part to the second part in a transport direction and having a notch, the printing device comprising:

a printing head disposed between the first part and the second part and adapted to eject ink to the medium;

a pair of rollers adapted to nip the medium to form a nip portion therebetween, at least one of the pair of rollers linked to an elastic member and urged to face each of the rollers by the elastic member;

a driver operable to drive one of the pair of rollers so that the pair of rollers transport the medium from the first part to the second part in the transport direction;

an anticipator anticipating a location of the notch; and

a controller operable to control the driver so as to the one of the pair of rollers cause to resist being urged by the elastic member almost when the notch corresponds to the nip portion in association with the location anticipated by the anticipator.

According to an aspect of the invention, the controller, based on the anticipation of the anticipator, exerts drive control of the driver in the vicinity where the roller pair reaches the notch. When reaching the roller pair, a shoulder of the notch on a paper discharge side is subjected by the urging force of the elastic member to an urging force (so-called “kicking”) directed toward the discharge side. However, a drive force that resists the urging force of the elastic member is imparted to the driver by the drive control. Therefore, the driver can resist “kicking” caused by the elastic member, so that the medium can be held by the roller pair.

“Kicking” is thus prevented, whereby the medium can be prevented from being inclined due to “kicking”. Therefore, the medium is not inclined in the middle when printing is being performed on the medium, thus making it possible to make print quality satisfactory. Besides, no “kicking” occurs, so that margin-less printing can be satisfactorily performed on the medium. Furthermore, the first acquirer detects whether or not the medium provided with the notch exists in the widthwise direction, which therefore prevents that it is determined that no printing object exists. Consequently, when the medium is, for example, thick paper, it can be prevented that the carriage moves in the state where the gap adjusting mechanism malfunctions and thus that the printing head hits against the medium.

According to the present invention there is provided:

a printing device having a first part and a second part and printing an image on a medium adapted to be transported from the first part to the second part in a transport direction and having a first notch disposed at a back portion and a second notch disposed at a front portion in the transport direction, the printing device comprising:

a printing head disposed between the first part and the second part and adapted to eject ink to the medium;

a first pair of rollers adapted to nip the medium to form a nip portion therebetween;

a driver operable to drive one of the first pair of rollers so that the first pair of rollers transport the medium from the first part to the second part in the transport direction;

a first acquirer disposed between the second part and the first pair of the rollers and operable to move in a widthwise direction perpendicular to the transport direction of the medium so as to acquire one of present information and absent information of the medium in the widthwise direction;

a fixer fixing a reference point at which the absent information turns to the present information;

a storage storing first predetermined drive-transport information for the driver from a predetermined reference point corresponding to the reference point to a first switching point disposed between the front portion and the first notch;

a second acquirer acquiring drive-transport information of the driver in association with the present information;

a third acquirer acquiring first correspondence information between the nip portion and the first switching point in association with the drive-transport information and the first predetermined drive-transport information; and

a controller operable to control the driver in association with the first correspondence information so that first driving speed of the driver before the first switching point corresponds to the nip portion is larger than second driving speed of the driver after the first switching point corresponds to the nip portion.

According to an aspect of the invention, when there occurs a change in the presence/absence of the medium which is detected by the first acquirer, the fixer determines the change and sets the changed detection point as the reference point. Besides, based on the amount of drive stored in the storage, the third acquirer counts an amount transported by the driver from the reference point and determines whether or not the roller pair has reached the switching point. Besides, when it is determined that the roller pair has reached the switching point, the controller exerts control to reduce the drive speed of the driver after the switching point is passed as compared with the drive speed thereof between the reference point and the switching point.

Consequently, from the reference point to switching point of an amount of the medium transported, the drive speed of the driver is made higher than the drive speed thereof after the switching point is passed. Here, the switching point is positioned closer to the paper discharge side than the first notch. Therefore, when the second notch of the medium reaches the roller pair, a side edge portion (stepped portion) of the first notch on the paper discharge side is crossed at a low drive speed. Here, when reaching the roller pair, the stepped portion of the first notch on the paper discharge side is subjected by the urging force of the elastic member to a urging force (so-called “kicking”) directed toward the discharge side. However, since the drive speed of the driver is reduced after the switching point is passed, the urging force of the elastic member can be resisted, for example, using the load of a train of drive wheels for transmitting a drive force from the drive source. Thus, “kicking” is prevented, so that the medium can be held by the roller pair.

Thereby, the medium can be prevented from being inclined due to “kicking”. Therefore, the medium is not inclined in the middle when printing is being performed on the medium, so that the medium can be made satisfactory. Besides, since no “kicking” occurs, margin-less printing can be satisfactorily performed on the medium. Furthermore, the first acquirer detects whether or not the medium provided with the notches exists in the widthwise direction, which therefore prevents that it is determined that no medium exists. Consequently, when the medium is, for example, thick paper, it can be prevented that the carriage moves in the state where the gap adjusting mechanism malfunctions and thus that the printing head hits the medium.

The printing device according to the invention may have the following structure in addition to the device described above. More specifically, at least one of the first pair of rollers are linked to an elastic member and urged to face each of the rollers by the elastic member, and the controller controls the second speed so that the one of the first pair of rollers resist being urged by the elastic member.

According to an aspect of the invention, “kicking” of the medium by the elastic member can be more reliably prevented.

The printing device according to the invention may have the following structure in addition to the device described above. More specifically, the driver includes a DC motor.

According to an aspect of the invention, the drive speed of the driver is switched to a low-speed side after the switching point is passed. In this case, the driver is a DC motor, so that a drive torque can be easily increased/reduced.

The printing device according to the invention may have the following structure in addition to the device described above. More specifically, the printing device further comprises a carriage retaining the printing head and the first acquirer.

According to an aspect of the invention, when the carriage is moved in the main scan direction to execute printing on the medium by ejecting ink from the printing head, detection of the medium in the widthwise direction is performed by the first acquirer simultaneously with the execution of printing. Therefore, it is determined whether or not the medium exists in the widthwise direction, thereby determining whether or not the notch exists in the widthwise direction. Besides, such detection in the widthwise direction is performed, thereby making it possible to recognize whether a paper feed completion position is reached or not.

The printing device according to the invention may have the following structure in addition to the device described above. More specifically, the medium comprises the front portion, the back portion and a print portion arranged between the front portion and the back portion, the second notch is brought contact with the print portion at a boundary portion disposed between the print portion and the back portion, and the first acquirer acquires the present information at the boundary portion.

According to an aspect of the invention, a side edge portion of the second notch on the paper feed side is determined to be the reference point. Therefore, the second notch can be set as the reference of an amount of the medium transported, thus making it possible to more reliably exert the drive control up to the switching point.

The printing device according to the invention may have the following structure in addition to the device described above. More specifically, the printing device further comprises a second pair of rollers is disposed between the second part and the first acquirer and is adapted to transport the medium to the second part.

According to an aspect of the invention, the transport roller pair is disposed closer to the paper feed side than the first acquirer, and the paper discharge roller pair is disposed closer to the paper discharge side than the first acquirer. Consequently, even when the back end portion of the medium passes the transport roller pair, the medium is transported by the transport roller pair. Therefore, printing continues to be executed on the medium, thus making it possible to discharge the medium.

The printing device according to the invention may have the following structure in addition to the device described above. More specifically, the second notch and the first notch are diagonally disposed at opposite ends of the medium in the transport direction.

According to an aspect of the invention, the two notches are positioned on the paper feed side and on the paper discharge side, respectively, no matter which lengthwise side of the medium, the medium may be fed from. Besides, even in such medium, the reference point can be reliably detected, and so-called “kicking” can be prevented from occurring.

The printing device according to the invention may have the following structure in addition to the device described above. More specifically, the medium comprises the front portion, the back portion and a print portion arranged between the front portion and the back portion, the second notch is brought contact with the print portion at a boundary portion disposed between the print portion and the back portion, the printing head has a ejecting element extending in the transport direction and is adapted to cause the ejecting element to eject the ink to the medium, the storage stores second predetermined drive-transport information for the driver from a predetermined reference point corresponding to the reference point to the boundary portion, and the third acquirer acquires second correspondence information between a back end portion of the ejecting element in the transport direction and the boundary portion in association with the drive-transport information and the second predetermined drive-transport information.

According to an aspect of the invention, the amount of paper feed drive of the driver is stored in the storage. And, based on the stored amount of paper feed drive, the third acquirer counts the amount transported by the driver from the reference point, thus determining whether or not the paper feed side end of the printing head reaches the side edge portion. Thereby, the paper feed completion position of the medium is detected.

The printing device according to the invention may have the following structure in addition to the device described above. More specifically, the medium comprises the front portion, the back portion and a print portion arranged between the front portion and the back portion, the first notch is brought contact with the print portion at a boundary portion disposed between the print portion and the back portion, the storage stores second predetermined drive-transport information for the driver from the first switching point to a second switching point disposed between the boundary portion and a back edge portion of the medium in the transport direction, the third acquirer acquires second correspondence information between the second nip portion and the nip portion in association with the drive-transport information and the second predetermined drive-transport information, and the controller is operable to control the driver so that third driving speed of the driver after the second switching point corresponds to the nip portion is larger than fourth driving speed of the driver after the second switching point corresponds to the nip portion.

According to an aspect of the invention, when the roller pair passes the second switching point, the drive speed of the driver increases, so that a discharge speed can be increased.

According to the present invention there is provided:

a method of controlling a driver operable to drive a first roller adapted to nip a medium, having a first notch disposed at a back portion and a second notch disposed at a front portion in the transport direction, together with a second roller to form a nip portion and operable to transport the medium together with the second roller from a first part to a second part in the transport direction in a printing device that prints an image on the medium and stores predetermined drive-transport information for the driver from a predetermined reference point to a switching point disposed between the front portion and the first notch, the method comprising:

transporting the medium from the first part to the second part in the transport direction;

acquiring one of present information and absent information of the medium in a widthwise direction perpendicular to the transport direction of the medium;

fixing a reference point at which the absent information turns to the present information, the reference point corresponding to the predetermined reference point;

acquiring drive-transport information of the driver in association with the present information;

acquiring correspondence information between the nip portion and the switching point in association with the drive-transport information and the predetermined drive-transport information; and controlling the driver in association with the correspondence information so that first driving speed of the driver before the switching point corresponds to the nip portion is larger than second driving speed of the driver after the switching point corresponds to the nip portion.

According to an aspect of the invention, when there occurs a change in the presence/absence of the medium which is detected in a detection step, then in a reference point determination step, the change is determined and the detection point at which the change occurs is set as a reference point. And, in a transport amount determination step, based on the amount of drive which is stored in the storage, the amount transported by the driver from the reference point is counted, thus determining whether or not the roller pair has reached the switching point. Besides, in a drive control step, when it is determined that the roller pair has reached the switching point, the control is exerted to reduce the drive speed of the driver after the switching point is passed as compared with the drive speed thereof between the reference point and the switching point.

Consequently, from the reference point to switching point of an amount of the medium transported, the drive speed of the driver is made higher than the drive speed after the switching point is passed. Here, the switching point is positioned closer to the paper discharge side than the first notch. Therefore, when the first notch of the medium reaches the roller pair, the side edge portion (stepped portion) of the first notch on the paper discharge side is crossed at a low drive speed. Here, when reaching the roller pair, the stepped portion of the second notch on the paper discharge side is subjected by the urging force of the elastic member to a urgsing force (so-called “kicking”) directed toward the discharge side. However, since the drive speed of the drivers reduced after the switching point is passed, the urging force of the elastic member can be resisted, for example, using the load of a train of drive wheels for transmitting a drive force from the driver. Thus, “kicking” is prevented, so that the medium can be held by the roller pair.

Thereby, the medium can be prevented from being inclined due to “kicking”. Therefore, the medium is not inclined in the middle when printing is being performed on the medium, so that the medium can be made satisfactory. Besides, since no “kicking” occurs, margin-less printing can be satisfactorily performed on the medium. Furthermore, the first acquirer detects whether or not the medium provided with the notches exists in the widthwise direction, which therefore prevents that it is determined that no medium exists. Consequently, when the medium is, for example, thick paper, it can be prevented that the carriage moves in the state where the gap adjusting mechanism malfunctions and thus that the printing head hits the medium.

According to the present invention there is provided:

a printing device having a first part and a second part and printing an image on a medium adapted to be transported from the first part to the second part in a transport direction and having a notch, the printing device comprising: to a printing head disposed between the first part and the second part and adapted to eject ink to the medium;

a first pair of rollers adapted to nip the medium to form a nip portion therebetween;

a second pair of rollers disposed between the second part and the first is pair of rollers and adapted to nip the medium;

a driver operable to drive one of the first pair of rollers and one of the second pair of rollers in association with driving information so that the first pair of rollers and the second pair of rollers transport the medium from the first part to the second part in the transport direction;

an anticipator anticipating a location of one of the notch and a back end portion of the medium in the transport direction;

a storage storing at least two correction information related to the driving information; and a controller operable to control the driver so as to correct the driving information by first one of the correction information before the one of the notch and the back end portion corresponds to the nip portion and so as to correct the driving information by second one of the correction information after the one of the notch and the back end portion corresponds to the nip portion in association with the location anticipated by the anticipator.

According to an aspect of the invention, the anticipator anticipates the position of the notch of or the back end portion of the medium, and based on this anticipation, the correction information for making a drive correction is switched in the vicinity where the transport roller pair reaches the notch or the back end portion. Therefore, the driving information of the driver is corrected by switching the correction information between when the medium is transported by both the transport roller pair and the paper discharge roller pair and when the medium is transported by only the paper discharge roller pair. Accordingly, the transport error can be properly corrected according to whether or not the medium comes off the transport roller pair. Besides, since there is provided the anticipator, it is possible to resolve the problem in which the existence of the notch prevents the position of the rear end portion of the medium from being detected using the paper detector.

According to the present invention there is provided:

a printing device having a first part and a second part and printing an image on a medium having a notch and adapted to be transported from the first part to the second part in a transport direction, the printing device comprising: a printing head disposed between the first part and the second part and adapted to eject ink to the medium;

a first pair of rollers adapted to nip the medium to form a nip portion therebetween;

a second pair of rollers disposed between the second part and the first pair of rollers and adapted to nip the medium;

a driver operable to drive one of the first pair of rollers and one of the second pair of rollers in association with driving information so that the first pair of rollers and the second pair of rollers transport the medium from the first part to the second part in the transport direction;

a first storage storing the driving information and at least two correction information related to the driving information;

a first acquirer disposed between the second part and the first pair of the rollers and operable to move in a widthwise direction perpendicular to the transport direction of the medium so as to acquire present information and absent information of the medium in the widthwise direction;

a fixer fixing a reference point at which the absent information turns to the present information;

a second storage storing first predetermined drive-transport information for the driver from a predetermined reference point corresponding to the reference point to a back end portion of the medium in the transport direction;

a second acquirer acquiring drive-transport information of the driver in association with the present information;

a third acquirer acquiring first correspondence information between the nip portion and the back end portion in association with the drive-transport information and the first predetermined drive-transport information; and

a controller operable to control the driver so as to correct the driving information by first one of the correction information before the back end portion corresponds to the nip portion and so as to correct the driving information by second one of the correction information after the back end portion corresponds to the nip portion in association with the first correspondence information.

According to an aspect of the invention, the first acquirer detects the reference point, and the fixer determines whether this reference point is reached or not. Besides, the third acquirer determines whether or not the transport roller pair has reached the back end portion of an amount of the medium transported. And, the correction information for correcting the driving information is switched according to the determination as to whether the back end portion is reached or not, thus exerting the drive control of the driver. Therefore, the driving information of the driver is corrected by switching the correction information between when the medium is transported by both the transport roller pair and the paper discharge roller pair and when the medium is transported by only the paper discharge roller pair. Accordingly, the transport error can be properly corrected according to whether or not the medium comes off the transport roller pair. Besides, there is provided the first acquirer that detects the presence/absence of the medium in the widthwise direction, and the reference point of an amount of the medium transported is set based on this detection. Therefore, the medium is properly transported even when the existence of the notch prevents the position of the back end portion of the medium from being detected using the paper detector, so that the correction information can be switched in response to the position of the back end portion of the medium.

The printing device according to the invention may have the following structure in addition to the device described above. More specifically, the first storage stores first correction information related to the driving information, the second storage stores second predetermined drive-transport information for the driver from a predetermined reference point corresponding to the reference point to the notch, the third acquirer acquires second correspondence information between the nip portion and the notch in association with the drive-transport information and the second predetermined drive-transport information, and the controller is operable to control the driver so as to correct the driving information by the first correction information after the notch corresponds to the nip portion in association with the second correspondence information.

According to an aspect of the invention, even when the transport roller pair reaches the notch, the driving information can be corrected based on the first correction information. Accordingly, the driver can be properly controlled and driven even in the notch that varies in the friction force of the transport roller pair, so that the correction of the transport error can be made more appropriate.

The printing device according to the invention may have the following structure in addition to the device described above. More specifically, the at least two correction information include second correction information and third correction information, the controller is operable to control the driver so as to correct the driving information by the second correction information before the notch corresponds to the nip portion in association with the second correspondence information, and the controller is operable to control the driver so as to correct the driving information by the third correction information after the back end portion corresponds to the nip portion in association with the first correspondence information.

According to an aspect of the invention, the transport error can be appropriately corrected: using the second correction information when the transport roller pair is positioned between the reference point and the notch; using the first correction information when the transport roller pair is positioned between the notch and back end portion; and using the third correction information when the transport roller pair is positioned between the notch and the rear end.

The printing device according to the invention may have the following structure in addition to the device described above. More specifically, the correction information includes a first correction value related to a manufacturing error of the printing device, a second correction value related to one of the medium and a part of the printing device and a third correction value related to print resolution of the printing device.

According to an aspect of the invention, each correction information responsive to whether or not the medium comes off the transport roller pair reflects a transport error resulting from a manufacturing error, a transport error that differs with each kind of medium or each transport region, and a transport error that differs with each print resolution. Therefore, the printing object can be more accurately transported.

The printing device according to the invention may have the following structure in addition to the device described above. More specifically, the notch includes a first notch disposed at the back end portion of the medium and a second notch disposed at a front end portion of the medium in the transport direction and being diagonal to the first notch, the second storage stores second predetermined drive-transport information for the driver from a predetermined reference point corresponding to the reference point to a first switching point disposed between the first notch and a front edge portion of the medium in the transport direction, the third acquirer acquires second correspondence information between the nip portion and the first switching point in association with the drive-transport information and the second predetermined drive-transport information, and the controller is operable to control the driver in association with the second correspondence information so that first driving speed of the driver before the first switching point corresponds to the nip portion is larger than second driving speed of the driver after the first switching point corresponds to the nip portion.

According to an aspect of the invention, no matter which lengthwise side of the medium, the medium may be fed from, the two notches are positioned on the paper feed side and on the paper discharge side, respectively. Besides, when the third acquirer determines that medium is transported to the switching point, the control section exerts control to reduce the drive speed of the driver after the switching point is passed as compared with the drive speed thereof between the reference point and the switching point. Therefore, for example, by using the load of a train of drive wheels for transmitting a drive force from the driver, “kicking” of the medium by the elastic member can be prevented from occurring in the first notch of the medium.

The printing device according to the invention may have the following structure in addition to the device described above. More specifically, the second storage stores third predetermined drive-transport information for the driver from a predetermined reference point corresponding to the reference point to a second switching point disposed between the first notch and a back edge portion of the medium in the transport direction, the third acquirer acquires third correspondence information between the nip portion and the second switching point in association with the drive-transport information and the third predetermined drive-transport information, and the controller is operable to control the driver in association with the third correspondence information so that third driving speed of the driver before the second switching point corresponds to the nip portion is smaller than fourth driving speed of the driver after the second switching point corresponds to the nip portion.

According to an aspect of the invention, the drive speed of the driver increases when the roller pair passes the second switching point, so that a discharge speed can be increased.

The printing device according to the invention may have the following structure in addition to the device described above. More specifically, the driver includes a DC motor.

According to an aspect of the invention, the drive speed of the driver is switched to a low-speed side after the roller pair passes the switching point. In this case, since the driver is a DC motor, a drive torque can be easily increased/reduced.

The printing device according to the invention may have the following structure in addition to the device described above. More specifically, the printing device further comprises a carriage retaining the printing head and the first acquirer.

According to an aspect of the invention, when the carriage is moved in the main scan direction to execute printing on the medium by ejecting ink from a printing head, then simultaneously with the execution of printing, the first acquirer detects the medium in the widthwise direction. Therefore, it is determined whether or not the medium exists in the widthwise direction, thereby determining whether or not the notch exists in the widthwise direction. Besides, such detection in the widthwise direction is performed, thereby making it possible to immediately recognize whether a paper feed completion position is reached or not.

According to the present invention there is provided:

a method of controlling a driver operable to drive a first roller in association with driving information, the first roller adapted to nip a medium having a notch together with a second roller to form a nip portion and operable to transport the medium together with the second roller from a first part to a second part in a transport direction in a printing device that prints an image on the medium and stores a first correction information related to the driving information, a second correction information related to the driving information and predetermined drive-transport information for the driver from a predetermined reference point to a back end portion of the medium in the transport direction, the method comprising:

transporting the medium from the first part to the second part in the transport direction;

acquiring one of present information and absent information of the medium in a widthwise direction perpendicular to the transport direction of the medium;

fixing a reference point at which the absent information turns to the present information, the reference point corresponding to the predetermined reference point;

correcting the driving information by the first correction information in association with the reference point;

acquiring drive-transport information of the driver in association with the present information;

acquiring correspondence information between the nip portion and the back end portion in association with the drive-transport information and the predetermined drive-transport information;

correcting the driving information by the second correction information in association with the correspondence information; and

controlling the driver in association with the driving information corrected by the second correction information.

According to an aspect of the invention, if there occurs a change in the presence/absence of the medium which is detected in a detection step, then in a first correction step, the driving information is corrected based on the first correction information. Besides, if there occurs a change in the presence/absence of the medium which is detected in the detection step, then in a reference point determination step, the change is determined and a detection point at which the change occurs is set as the reference point. And in a transport amount determination step, the amount transported by the driver is counted based on a drive amount stored in the storage, thus determining whether or not the transport roller pair has reached the back end portion of the amount of the medium transported. Furthermore, in a second correction step, the driving information is corrected, and thereafter, in a drive control step, if it is determined that the transport roller pair has reached the rear end, the drive control of the drive source is exerted based on the driving information corrected using the second correction information.

Consequently, the driving of the driver is corrected by switching the correction information between when the medium is transported by both the transport roller pair and the paper discharge roller pair and when the medium is transported by only the paper discharge roller pair. Accordingly, the transport error can be properly corrected according to whether or not the medium comes off the transport roller pair. Besides, since there is provided the detection step, it is possible to resolve the problem in which the existence of the notches prevents the position of the back end of the medium from being detected using the paper detector.

### BRIEF DESCRIPTION OF THE DRAWINGS

FIG. 1 is a perspective view showing the configuration of a printer according to one embodiment of the invention.

FIG. 2 is a sectional side view of a paper feed portion of the printer.

FIG. 3 is a schematic diagram showing the configuration of the printer.

FIG. 4 is a sectional side view showing the shape of the vicinity of a platen.

FIG. 5 is a block diagram of a control section that exerts various controls of the printer.

FIG. 6 is a diagram showing the outline configuration of an encoder.

FIG. 7 is a plan view showing the image in which a PF roller pair nips photo stand paper.

FIG. 8 is a side view showing the image in which the PF roller pair nips the photo stand paper.

FIG. 9 is a flowchart showing the control of a PF motor.

FIG. 10 is a flowchart showing the control of a PF motor.

FIG. 11 is a flowchart showing a transport error correction of a normal printing object.

FIG. 12 is a flowchart showing a transport error correction of a photo cardboard.

FIG. 13 is a fragmentary plan view showing how margin-less printing is performed on a photo cardboard.

### DETAIL DESCRIPTION OF PREFERRED EMBODIMENTS

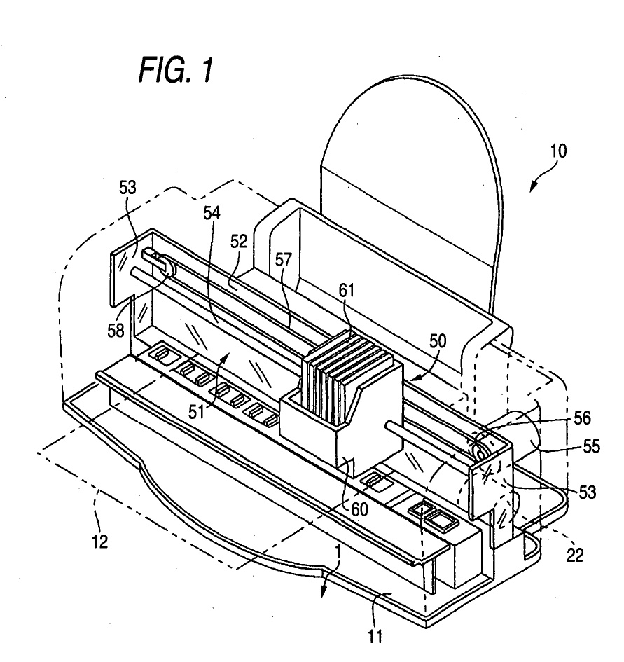

A printer of the invention will hereinafter be described with reference to FIGS. 1 to 13.

A printer 10 of the invention is an inkjet printer, but such an inkjet printer may be any apparatus that adopts any ejection method as long as it is an apparatus capable of printing by ejecting ink.

As used in the description below, the term “lower side” refers to the side of an installation surface 1 on which the printer 10 is installed, and the term “upper side” refers to the side of the printer 10 away from the installation surface 1. Besides, a direction in which a to-be-described carriage 60 moves is defined as a main scan direction, and a direction perpendicular to the main scan direction, in which a printing object 12 is transported, is defined as a sub-scan direction. Besides, the side of the printer 10 toward which the printing object 12 is fed is described as a paper feed side (rear end side), and the side thereof from which the printing object 12 is discharged, as a paper discharge side (front side).

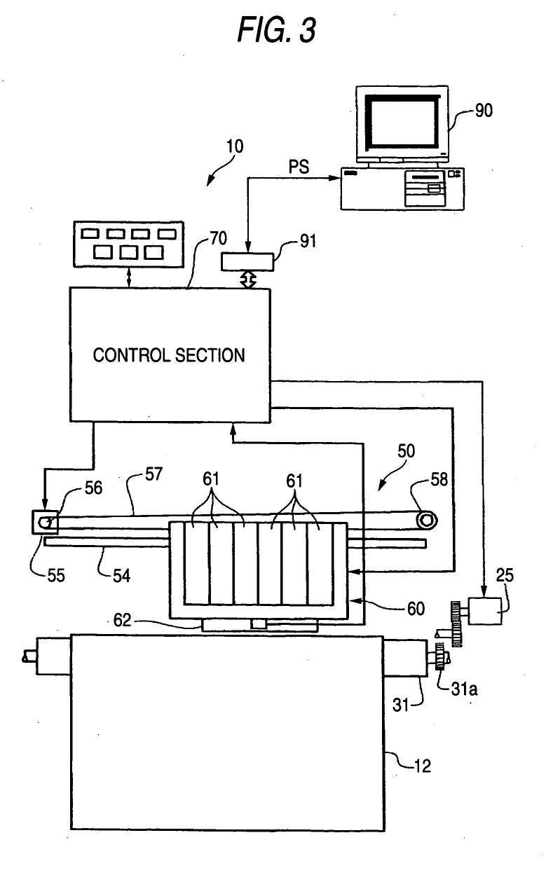

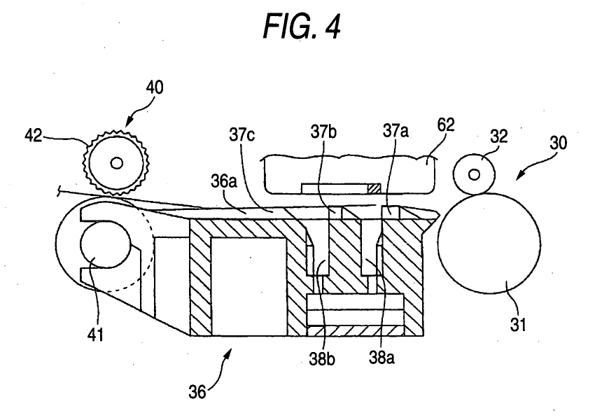

The printer 10 includes a chassis 11 in contact with the installation surface 1, and various units are mounted on this chassis 11. As the various units, there are a paper feed mechanism 20 that feeds the printing object 12 by means of a PF motor 25, a carriage mechanism 50 that reciprocates the carriage 60 in the main scan direction by means of a carriage motor (CR motor 55), and the like. In addition thereto, there exists a control section 70 shown in FIGS. 3 and 4.

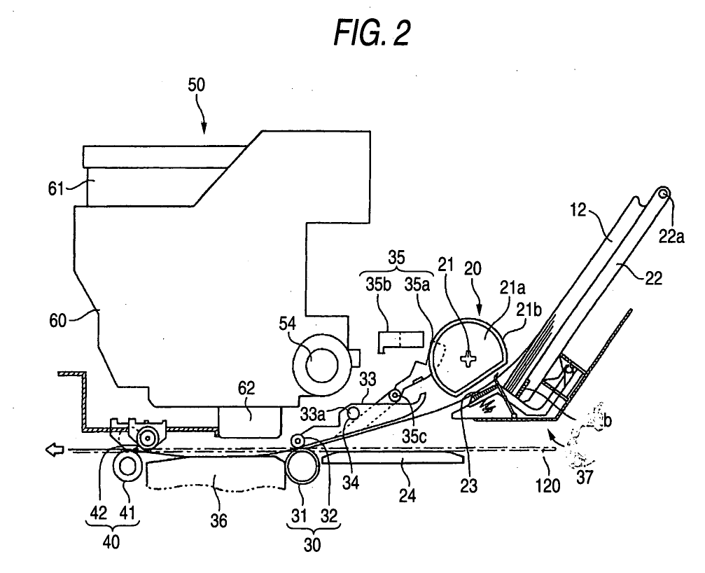

The detail of the paper feed mechanism 20 will now be described with reference to FIG. 2. The paper feed mechanism 20 shown in FIG. 2 includes a paper feed roller 21, a hopper 21, and a separation pad 23.

The paper feed roller 21, which is rotationally driven by the PF motor 25 shown in FIGS. 1 and 3, has a roller body 21a and a rubber material 21b wrapped around the outer periphery of the roller body 21a. Besides, this paper feed roller 21 is formed to have an approximate D-shape in side view. This paper feed roller 21 is configured such that the circular arc portion of the rubber material 21b feeds comparatively thin paper out of the printing object 12, and the flat portion of the rubber material 21b allows the paper to pass therethrough, thus preventing a transport load from being applied during transport operation by a paper discharge roller pair 40 on the paper discharge side.

The hopper 22, formed of a plate-like body on the upper surface of which the paper can be placed, is disposed in an inclined position as shown in the figure. Besides, the hopper 22 is disposed so as to be capable of oscillation about a pivot shaft 22a disposed in an upper portion thereof. And, the oscillation caused by a not-shown cam mechanism brings a lower end portion of the hopper 22 into elastic pressure contact or out of contact with the paper feed roller 21. When the paper feed roller 21 rotates in such pressure contact relationship, the top sheet of the stacked paper is fed toward the paper discharge side.

The separation pad 23, formed of a member having a high friction coefficient, is disposed at a position opposite the paper feed roller 21. When the paper feed roller 21 rotates, the circular arc portion of the rubber material 21b and the separation pad 32 make pressure contact with each other. The top sheet fed by the rotation of the paper feed roller 21 passes through this pressure contact portion and advances toward the paper discharge side. However, the next and subsequent sheets, which are ready to advance toward the paper discharge side together with the top sheet, are prevented by the existence of such a pressure contact portion from advancing toward the paper discharge side. Thereby, double or multiple feed is prevented.

Besides, a paper guide 24 formed of a plate-like body is substantially horizontally disposed to the paper discharge side of the paper feed mechanism 20. The front end of the sheet fed by the paper feed roller 21 abuts the paper guide 24 at an angle and thus is smoothly guided toward the paper discharge side. Besides, the PF roller pair 30, which is made up of a PF drive roller 31 and a PF driven roller 32, is disposed closer to the paper discharge side than the paper guide 24. Here, the PF driven roller 32 is always biased toward the PF driver roller 31 by action of the biasing force (elastic force) of a to-be-described spring 34.

Therefore, the PF drive roller 31 and driven roller 32 nip therebetween the printing object 12 fed through the hopper 22 side or a to-be-described opening 37 while applying a predetermined biasing force to the printing object 12. Besides, the PF drive roller 31 rotates as a driving force is transmitted thereto from the PF motor 25 shown in FIGS. 1 and 3. Therefore, when the PF motor 25 operates by an amount equivalent to one step at a fixed pitch, the printing object 12 nipped by the PF roller pair 30 is fed by an amount equivalent to one step toward the paper discharge side. Additionally, in the printer 10, there exists a not-shown train of speed-up gears which extends from the PF drive roller 31 toward the PF motor 25. Accordingly, unless a high torque acts on a PF drive roller 31 side, it is difficult to rotate the PF motor 25 from the PF drive roller 31 side.

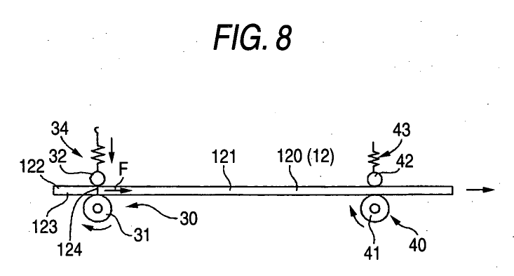

Here, the PF driven roller 32 is pivotally supported on the paper discharge side of a driven roller holder 33. The driven roller holder 33 is disposed so as to be pivotable about a pivot shaft 33a. Besides, the driven roller holder 33 is pivotally biased by the spring 34 serving as the elastic member in the direction (a counterclockwise direction as seen in FIG. 2) in which the PF driven roller 32 always makes pressure contact with the PF drive roller 31. Additionally, the spring 34, which is a torsion coil spring, is inserted in the pivot shaft 33a. However, in FIG. 8, the spring 34 is schematically shown as a normal coil spring (the same applies to a spring 43).

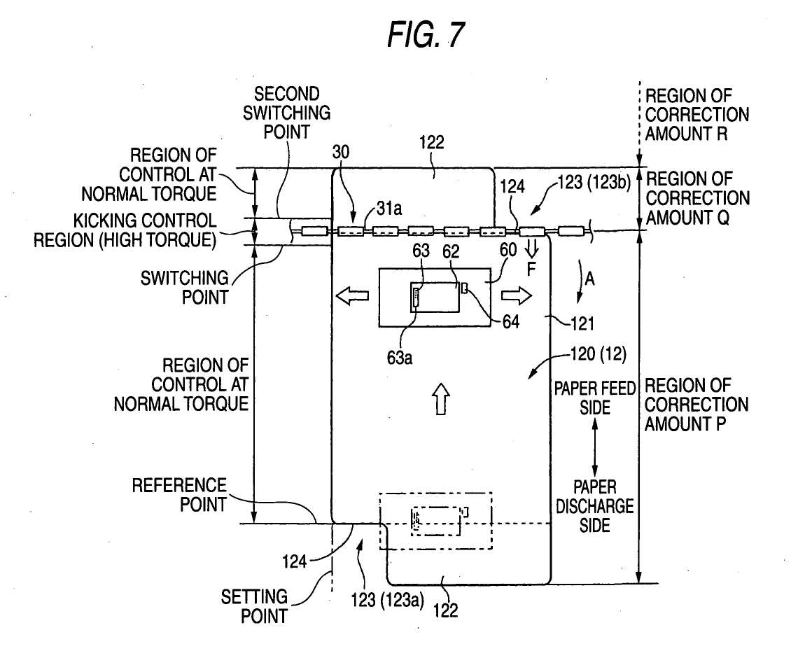

Besides, the PF drive roller 31 includes a shaft body 31 a (see FIG. 7) that, made of material such as metal, is elongated in the main scan direction (a direction perpendicular to the plane of FIG. 2). And, a high-friction grip body 31b is integrally deposited on the surface of this shaft body 31a. Besides, a plurality of the PF driven rollers 32 and a plurality of the driven roller holders 33 are arrayed in the axial direction of the PF drive roller 31.

On the other hand, in the PF driven roller 32, its surface in contact with the PF drive roller 31 is made up of a member (not shown) with lower friction than that of the grip body 31b, and this low-friction member is formed to cover the outer peripheral surface of the shaft body 31a made of material such as metal.

Besides, a paper detector 35 that detects passage of the printing object 12 is disposed in the vicinity of the driven roller holder 33 positioned on the 0th column side (the front side of the plane of FIG. 2). The paper detector 35 includes a sensor body 35b and a detection lever 35a. Out of them, the detection lever 35a, formed to have a substantially dog-legged shape in side view, is disposed so as to be pivotable about a pivot shaft 35c in the vicinity of the center of the dog-legged shape. Besides, the sensor body 35b, positioned above the detection lever 35a, includes a light emitting portion (not shown) and a light receiving portion (not shown) that receives light from the light emitting portion. And, an upper portion of the detection lever 35a above the pivot shaft 35c is configured to, by its pivotal movement, interrupt and allow passage of the light directed from the light emitting portion to the light receiving portion.

Accordingly, as shown in FIG. 2, when the detection lever 35a pivots as it is pushed upward with the passage of the printing object 12, the upper portion of the detection lever 35a falls out of the sensor body 35b. Thereby, the light receiving portion is placed in a light receiving position, thus detecting the passage of the front end of the printing object 12. Besides, when the rear end of the printing object 12 passes through the detection lever 35a, the detection lever 35a pivots in the downward and return direction. Thereby, the light receiving portion is switched to a non-light-receiving position, thus detecting the passage of the rear end of the printing object 12.

Additionally, in this embodiment, the printing object 12 uses to-be-described photo stand paper 120 provided with a notch 123, and a fixed distance exists between the photo stand paper 120 and the paper detector 35. Therefore, the state is such that paper detection cannot be performed using the paper detector 35.

Besides, on the paper discharge side of the PF drive roller 31, a platen 36 and a printhead 62 are disposed vertically opposite each other. The platen 36 supports, from below, the printing object 12 that is transported beneath the printhead 62 by the PF roller pair 30.

Now, FIG. 4 shows a sectional side view of the platen 36. As shown in FIG. 4, the platen 36 has ribs 37a, 37b, and 37c projecting upward from a reference plane 36a of the platen 36. These ribs 37a, 37b, and 37c are aligned in series with each other in the sub-scan direction, thus allowing satisfactory transport of the printing object 12.

Besides, in the main scan direction, the rib 37a is intermittently spaced a predetermined distance away from another rib 37a, and the reference plane 36 exists between the adjacent ribs 37a and 37a. However, the platen 36 need be made responsive to margin-less printing for printing a margin of a prescribed printing object 12 such as the photo stand paper 120. Therefore, a recess (not shown) that extends along the sub-scan direction and is downwardly recessed is formed in a portion of the reference plane 36a which reaches the margin of the prescribed printing object 12. Besides, recesses 38a and 38b extending in the main scan direction exist between the ribs 37a and 37b and between the ribs 37b and 37c, respectively.

Besides, similar to the PF roller pair 30, a paper discharge roller pair 40 corresponding to the roller pair is disposed on the paper discharge side of the platen 36. The paper discharge roller pair 40 includes a paper discharge drive roller 41 corresponding to the second driver roller and a paper discharge driven roller 42 corresponding to the second driven roller. Similar to the PF drive roller 31, the paper discharge drive roller 41 rotates as the driving force from the PF motor 25 is transmitted thereto. Besides, similar to the PF driven roller 32, the paper discharge driven roller 42 is biased by a spring 43 in the direction in which the paper discharge driven roller 42 always makes pressure contact with the paper discharge drive roller 41.

And, the printing object 12 is nipped by the paper discharge roller pair 40 with a predetermined biasing force applied thereto. When the paper discharge drive roller 41 rotates in this state, the printing object 12 is discharged in the left direction as seen in FIG. 2. Additionally, the paper discharge drive roller 41 adopts the configuration in which a shaft extending in the widthwise direction of the printing object 12 has rubber rollers intermittently arranged thereon in the widthwise direction. Besides, the PF motor 25 adopts the configuration of distributing its driving force to the PF driver roller 31 and the paper discharge drive roller 41. However, the invention may adopt the configuration in which there is provided a separate motor other than the PF motor 25 and the paper discharge drive roller 41 is driven by the separate motor.

Besides, the opening 37 is provided below the hopper 22. The opening 37, which is an opening portion provided on the rear end side of the printer 10, has a width in the main scan direction which is wide enough to allow the printing object 12 to pass therethrough. Additionally, the to-be-described photo stand paper 120 is given as an example of the printing object 12 which is allowed to pass through the opening 37.

The carriage mechanism 50 will subsequently be described. As shown in FIGS. 1 and 3, the carriage mechanism 50 includes the carriage 60. Besides, the carriage mechanism 50 includes a support frame 51, a carriage shaft 54 that is supported by this support frame 51 and slidably supports the carriage 60, the carriage motor (CR motor 55) disposed on the back side of a to-be-described shield plate 52, a gear pulley 56 attached to this CR motor 55, an endless belt 57, and a driven pulley 58 having this endless belt 57 stretched between itself and the gear pulley 56.

As shown in FIG. 1, the support frame 51 includes the shield plate 52 and lateral plates 53 formed by folding both end sides of the shield plate 52 toward the paper discharge side. The carriage shaft 54 is supported on the paired lateral plates 53 so as to extend along the lengthwise direction of the chassis 11. Besides, the CR motor 55 that drives the gear pulley 56 is disposed on the back side of the shield plate 52.

Besides, the carriage 60 is disposed opposite the platen 36. As shown in FIG. 1, six cartridges 61 having stored therein respective inks of black (K), light magenta (LM), light cyan (LC), cyan (C), magenta (M), and yellow (Y) are detachably mounted on the carriage 60. The number of mounted cartridges 61 for respective colors is not limited to six, but may be any number such as four, seven, and eight. Besides, the ink that fills the cartridges 61 are not limited to dye ink, but the cartridges 61 filled with another kind of ink such as pigment ink may be mounted on the carriage 60.

As shown in FIG. 7, the printhead 62 is disposed below the carriage 60. In the printhead 62, nozzles 63a serving as the ejection elements are arranged in rows in the direction of transport of the printing object 12, thus forming nozzle arrays 63 that correspond to the respective color inks. Additionally, in this embodiment, the nozzle arrays 63 include, for example, 180 nozzles 63a, out of which the 180th nozzle 63a is positioned on the paper feed side and the first nozzle 63a is positioned on the paper discharge side.

Besides, a piezoelectric element (not shown) that is one kind of electrostrictive element and has excellent responsiveness is disposed for each nozzle 63a, in the nozzle arrays 63 that, formed below the carriage 60, are made to correspond to the respective inks. The piezoelectric element, which corresponds to the head drive means, is disposed at a position contacted on a wall surface formed with an ink path, and the wall surface is pushed by the actuation of this piezoelectric element, thus making it possible to eject ink droplets from the nozzle 63a formed at an end of the ink path.

Additionally, the printhead 62 is not limited to a piezoelectric drive method using the piezoelectric element, but may use another method. Given as main examples of the another method are a magnetostrictive method using a magnetostrictive element, an electrostatic method using an electrostatic force, and a mist method that controls a mist using an electric field.

Besides, a PW sensor 64 forming part of the detection means is attached to a portion below the carriage 60. The PW sensor 64, which is an optical sensor, includes a light source that projects light onto the printing object 12 and a line sensor (or a CCD element) that converts the light reflected off the printing object 12 into a corresponding image signal. The PW sensor 64 moves in the main scan direction with the movement of the carriage 60. On this occasion, the PW sensor 64 emits and receives light, thereby making it possible to determine whether the printing object 12 exists or not. Additionally, the 180th nozzle 63a and the PW sensor are disposed at the identical position. However, they may be configured to be positioned at different positions.

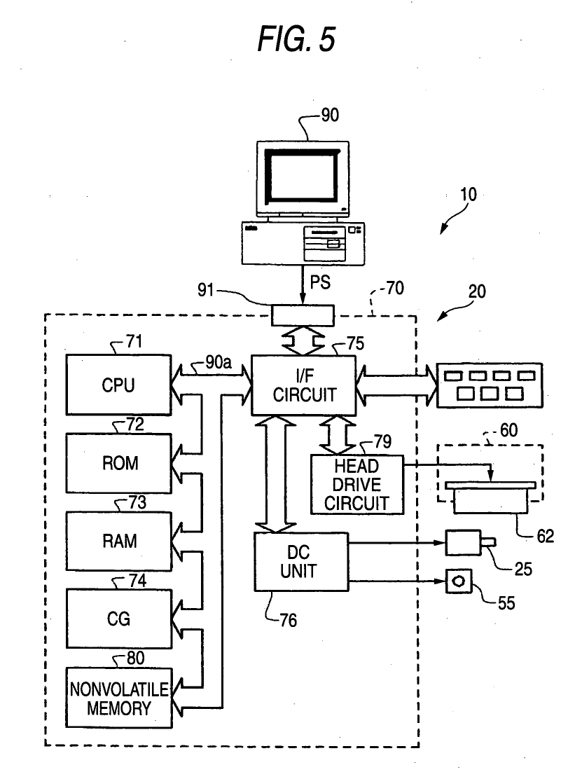

The configuration of the control section 70 will now be described with reference to FIG. 5 etc. The control section 70 includes, a bus 90a, a CPU 71, a ROM 72, a RAM 73, a character generator (CG) 74, an I/F circuit 75, a DC unit 76, a PF motor drive circuit 77, a CR motor drive circuit 78, a head drive circuit 79, a nonvolatile memory 80, and the like.

Besides, output signals from the paper detector 35, the PW sensor 64, a to-be-described rotary encoder 81, a not-shown linear encoder that detects the amount of movement of the carriage 60, a power switch that powers on/off the printer 10, and the like are inputted to the CPU 71 and the DC unit 76.

The CPU 71 performs computations for executing control programs of the printer 10 which are stored in the ROM 72, nonvolatile memory 80, and the like, and performs other necessary computations.

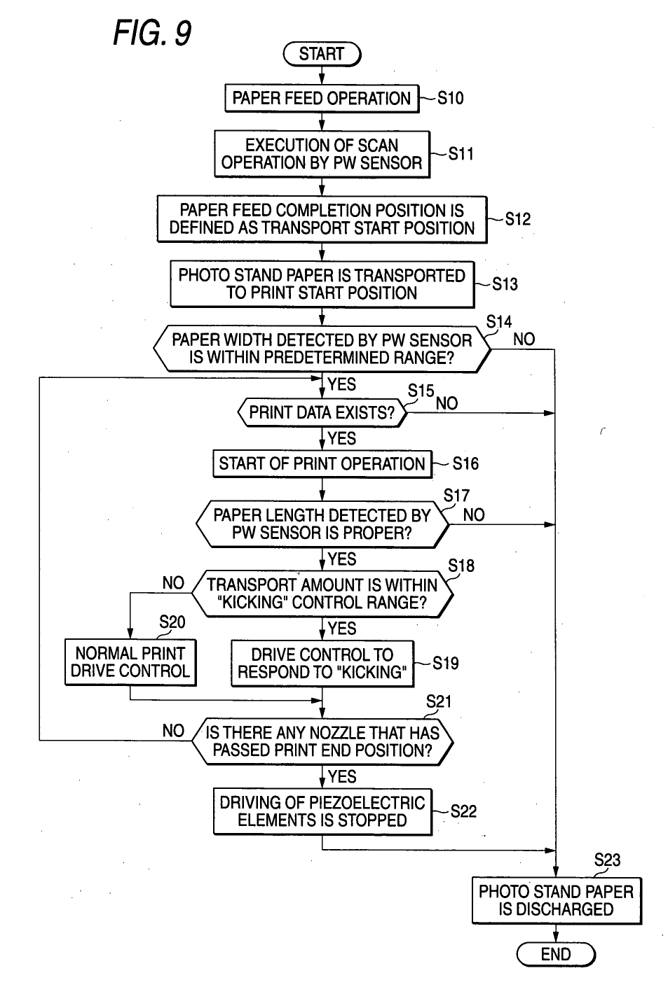

Besides, the control programs for controlling the printer 10, data necessary for processes, and the like are stored in the ROM 72. In the first embodiment of the invention, a drive control program and the like responsive to the kind of the printing object 12 are stored in the ROM 72. This drive control program enables the control and driving of the PF motor 25 which are based on detection of the PW sensor 64 and correspond to a to-be-described flowchart shown in FIG. 9. Besides, the I/F circuit 75 incorporates a parallel interface circuit and can receive a print signal supplied from a computer 90 via a connector 91.

The RAM 73 is a memory that temporarily stores, for example, a program being executed or data being calculated by the CPU 71. Besides, the nonvolatile memory 80 is a memory for storing various data that need be held even after the inkjet printer 10 is powered off.

Besides, the DC unit 76 is a control circuit for controlling the speed of the PF motor 25 and CR motor 55 that are a DC motor. The DC unit 76 performs various calculations for controlling the speed of the PF motor 25 and CR motor 55 based on a control instruction transmitted from the CPU 71, an output signal of the to-be-described rotary encoder 81, and an output signal of the paper detector 35. And, based on the calculation results, the DC unit 76 transmits a motor control signal to the PF motor drive circuit 77 and the CR motor drive circuit 78.

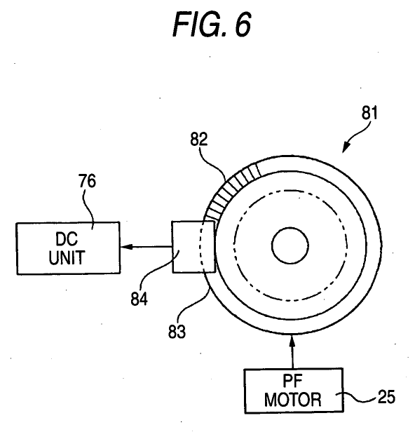

Now, as shown in FIG. 6, the rotary encoder 81 has: a disk-like scale 83 having a large number of slits 82; and a detector 84 including a not-shown light emitting portion that emits light to the slits 82 and a not-shown light receiving portion that receives the light passed through the slits 82. This rotary encoder 81, attached to the gear 31a (see FIG. 3) that transmits the driving force to the PF drive roller 31, is rotationally driven by the driving of the PF motor 25. And, when the disk-like scale 83 is rotated by the driving of the PF motor 25, the detector 84 outputs a rising signal and a decaying signal that are formed by the light passing through the slits 82. This enables calculation of the amount of rotation (rotation speed) of the PF drive roller 31, thus making it possible to exert the drive control of the PF motor 25.

Additionally, as an example of resolution of the rotary encoder 81, there is a resolution of 1/5760 inches in terms of the amount of the printing object 12 transported. In this case, the minimum unit of the amount of the printing object 12 transported is 1/5760 inches.

Besides, the PF motor drive circuit 77 controls the driving of the PF motor 25 based on the motor control signal from the DC unit 76. This PF motor 25 is a source of power to transport the printing object 12. Besides, the CR motor drive circuit 78 controls the driving of the CR motor 55 based on the motor control signal from the DC unit 76. Additionally, the PF motor 25 and the CR motor 55, in their stopped state, enable position maintenance. Besides, the head drive circuit 79 controls and drives the piezoelectric elements existing in the printhead 62 based on a signal for exerting such drive control from the CPU 71.

Additionally, the components of the control section 70 are connected together by the bus 70a that is a signal line. The CPU 71, ROM 72, RAM 73, CG 74, I/F circuit 75, nonvolatile memory 80, and the like are connected to each other through such a bus 70a, thus enabling transmission/reception of data therebetween.

Besides, FIG. 7 shows the shape of the photo stand paper 120 that is one kind of the printing object 12. The photo stand paper 120 is a cardboard member having a thickness on the order of, for example, 1.9 mm. This photo stand paper 120 is provided with a print portion 121 and board portions 122 adjoining this print portion 121. The board portions 122 each have a one-side edge aligned with the print portion 121 but are formed to have a narrower width than the print portion 121. Therefore, the photo stand paper 120 has substantially rectangular notches 123 formed on both upper and lower end sides of one diagonal thereof.

Additionally, portions of the print portion 121, which are situated on the border lines between themselves and the board portions 122 and are exposed to the notches 123, are defined as side edge portions 124. Out of the notches 123, the notch 123 positioned on the paper discharge side corresponds to the first notch (hereinafter identified as notch 123a according to need), and the notch 123 corresponding to the paper feed side corresponds to the second notch (hereinafter identified as notch 123b according to need).

The photo stand paper 120 is a cardboard member obtained by sticking two cardboards together, and the cardboard on the reverse side is provided with a perforated line along which the cardboard is torn and pulled out to form a support flap. The photo stand paper 120 is configured capable of cutting off the board portions 122 and furthermore tearing and pulling out the support flap after completion of printing on the print portion 121, thereby providing a photo stand that can stand on end.

The first embodiment of the control to operate the printer 10 using the above configuration will be described with reference to FIG. 9.

First, when a user sets the photo stand paper 120 and sends a print start command, a paper feed operation of feeding the photo stand paper 120 is started (step S10). In this case, the user inserts the photo stand paper 120, for example, from the opening 37. Then, by a transport operation of the PF motor 25, the photo stand paper 120 reaches the opening 37, and subsequently the front end thereof on the discharge side is nipped by the PF roller pair 30. And, the PF drive roller 31 is driven by the PF motor 25, thereby transporting the photo stand paper 120 toward the paper discharge side.

Besides, the CR motor 55 is also driven simultaneously with such a transport operation of the PF motor 25. And, the carriage 60 is driven in the main scan direction to cause the PW sensor 64 to execute a scan operation (see FIG. 7). A determination as to the presence/absence of the photo stand paper 120 and a recognition of the shape thereof are made through this scan operation. In this case, the PW sensor 64 performs the scan operation to the board portion 122 of the photo stand paper 120 which is positioned on the paper discharge side. Then, the notch 123a is also recognized at the same time, but cannot be recognized in this stage to be really the notch 123a (board portion 122).

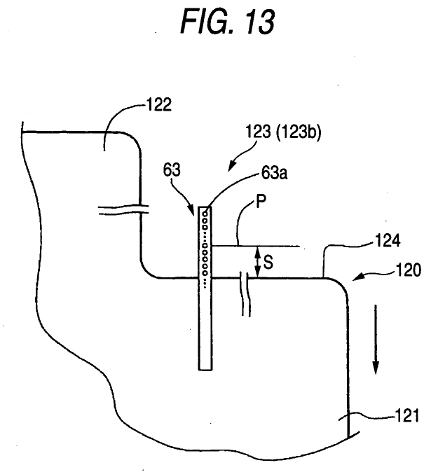

Subsequently, the PW sensor 64 executes the scan operation (step S11). That is, when the photo stand paper 120 is sequentially transported by the driving of the PF motor 25, a transition is made from the state in which the PW sensor 64 is opposite the board portion 122 to the state in which the PW sensor 64 is opposite the border portion between the board portion 122 and the print portion 121 (see FIGS. 7 and 13). Simultaneously, the PW sensor 64 is moved by the driving of the CR motor 55 to perform the scan operation. Then, the PW sensor 64 transmits to the CPU 71 a detection signal resulting from the difference in width between the board portion 122 and the print portion 121. The CPU 71 recognizes that the paper feed is completed as the PW sensor 64 reaches the side edge portion 124. That is, the paper feed is completed to make the print portion 121 ready to be printed. Additionally, when the CPU 71 recognizes the difference in width as the PW sensor 64 reaches the side edge portion 124, this recognition point provides a transport reference point. However, the front side end of the photo stand paper 120 may be set as the reference point.

Next, in step S12, the CPU 17 defines a paper feed completion position as a transport start position in the control and driving of the PF motor 25. That is, since paper detection by the paper detector 35 cannot be performed to the photo stand paper 120, the CPU 71, immediately after paper is fed, recognizes the paper as the photo stand paper 120 which is different from normal paper and switches its control to non-detection control of the paper detector 35. In this case, the amount of the photo stand paper 120 transported is counted based on and starting with the detection of the paper feed completion position by the PW sensor 64. Additionally, in this embodiment, the paper feed position is defined as the position at which the 180th nozzle 63a of the printhead 62 (the nozzle 63a closest to the paper feed side) substantially reaches the border line between the print portion 121 and the board portion 122. However, the paper feed completion position is not limited to this position, but may be modified in various ways.

Additionally, the non-detection control corresponds to the normal control region (which is also called control in an override region (a no-paper region of the paper detector 35)) of FIG. 7.

Next, the photo stand paper 120 is transported from this paper feed completion position to a print start position (step S13). Here, the print start position is defined as the position at which the first nozzle 63a of the printhead 62 substantially reaches the border line. The drive control of the PF motor 25 in this case is also performed by counting the transport amount. Besides, in step S14, the PW sensor 64 is used to determine a paper width. If, in this determination, the paper width does not match the paper width of a prescribed photo stand paper 120, the control proceeds to step S23. Besides, if the paper width matches the paper width of the prescribed photo stand paper 120, the control proceeds to the next step S15.

Subsequently, step S15 is executed. That is, if Yes is determined in step S14, or if the control passes through any one of steps S21 and S14, the CPU 71 determines whether or not print data exists in the RAM 73. If, in this determination, it is determined that the print data exists, the control proceeds to the next step S16. Besides, if it is determined that no print data exists, the control proceeds to step S23.

Next, if it is determined in step S15 that the print data exists, a print operation is started (step S16). This print operation is performed by driving the CR motor 55 to thereby move the carriage 60 in the main scan direction and also by controlling and driving the printhead 62. Additionally, the drive control of the PF motor 25 is exerted in either of to-be-described steps S19 or S21.

After step S16, the DC unit 76 uses the PW sensor 64 to determine the paper length of the photo stand paper 120 (step S17). In this determination, the paper length is determined improper, for example, if the PW sensor 64 reaches the notch 123a before the transport amount reaches a “kicking” control region, or if the notch 123a is not detected even after the transport amount passes the “kicking” control region. In this case, it is determined that the paper length does not match that of the prescribed photo stand paper 120, and the control proceeds to to-be-described step S23.

If Yes is determined in step S17, the DC unit 76 determines whether or not the amount of the photo stand paper 120 transported has reached a switching point (has reached the “kicking” control region) (step S18). This determination is made based on whether or not the amount thereof transported by the PF motor 25 has reached the “kicking” control region. That is, the rotary encoder 81 is used to calculate the amount (speed) of rotation of the PF drive roller 31, thereby determining whether or not the amount of the photo stand paper 120 transported has reached a transport amount sufficient to reach the “kicking” control region. If, in this determination, it is determined that the amount of the photo stand paper 120 transported has reached the “kicking” control region (if Yes), the control proceeds to the next step S19. Besides, if it is determined that the transport amount has not reached the “kicking” control region (if No), the control proceeds to to-be-described step S20.

If it is determined in step S18 that the transport amount has reached the “kicking” control region, the DC unit 76 controls the PF motor 25 so that the rotation seed of the PF motor 25 is reduced to drive the PF motor 25 by an amount equivalent to one step (one line) (step S19). That is, the DC unit 76 exerts control (hold current control) to make an applied voltage lower than that during printing and to reduce a current value as compared with that during printing.

In this “kicking” control, when the PF roller pair 30 reaches the side edge portion 124, a “kicking” force F directed in the paper discharge direction is imparted by the spring 34 to the photo stand paper 120 (see FIG. 8). Consequently, the control (hold current control) is exerted over the FP motor 25 so that a current having a value capable of resisting such a “kicking” force F is allowed to flow through the PF motor 25. Here, the train of speed-up gears exists in the printer 10, and unless a high torque acts on a PF drive roller 31 side, it is difficult to rotate the PF motor 25 from the PF drive roller 31 side. Accordingly, the “kicking” force F can be resisted by only exerting the control to reduce the current value or by only imparting the PF motor 25 with a driving force to direct the printing object 12 slightly toward the paper feed side. Additionally, when the “kicking” control is driven in the printhead 62 by an amount equivalent to one line, the control subsequently proceeds to to-be-described step S21.

Besides, if it is determined in the step S18 that the transport amount has not reached the “kicking” control region (if No), normal print drive control is exerted to drive the PF motor 25 by an amount equivalent to one step (one line) (step S20). In this normal print drive control, the rotation speed of the PF motor 25 is set to a rotation speed during normal printing (i.e., a higher rotation speed than that of step S19). In this case, the current value is made greater than in the step S19. After this print drive control in step S20 is exerted by an amount equivalent to one step (one line), the control proceeds to the next step S21.

Additionally, the amount of drive corresponding to the “kicking” control region and an amount of drive at a normal torque are pre-stored in the ROM 72. After the “kicking” control region is passed through as aforesaid, another region of control at the normal torque is reached, but a determination as to whether the control region is passed through or not is made based on whether the amount of drive pre-stored in the ROM 72 is reached or not. This amount of drive is an amount of drive before it is determined that the PF roller pair 30 has passed through a second switching point.

After the control passes through step S19 and step S20, it is subsequently determined whether or not the photo stand paper 120 has reached a prescribed print end position (step S21). Here, in this embodiment, the print end position is made to correspond to the margin-less printing on the print portion 121. That is, as shown in FIG. 13, the print end position is the region in which the 180th to Nth nozzles 63a do not reach an upper portion of the print portion 121, but reach the board portion 122 and the notch 123b.

In this region, during execution of the margin-less printing, the 180th nozzle 63a and nozzles 63a adjacent thereto come out of the print portion 121 and eject ink droplets even onto the platen 36. However, the recess 38a exists in the platen 36, and when the carriage 60 moves in the main scan direction during execution of the margin-less printing, the 180th nozzle 63a and nozzles 63a adjacent thereto become opposable to the recess 38a. Therefore, ink droplets overflowed out of the print portion 121 are dropped into the recess 38a, thus preventing another portion such as the ribs 37a to 37c from being contaminated.

If it is determined in the step S21 that the amount of the photo stand paper 120 transported has reached the prescribed print end position (if Yes), the driving of the piezoelectric elements is stopped to stop the operation of ejecting ink droplets (step S22). Here, as shown in FIG. 13, suppose that the photo stand paper 120 is transported, whereby the nozzle array 63 reaches a straight line P having a distance S with respect to the side edge portion 124. In this case, to perform the margin-less printing, the configuration need only be such as to eject ink droplets until before the 180th nozzle 63a passes the straight line P. That is, when the 180th nozzle 63a is in a range of the distance S, the piezoelectric elements need only be continued.

However, when the photo stand paper 120 is further transported after the 180th nozzle 63a passes the straight line P, the rib 37b (see FIG. 4) of the platen 36 is exposed as shown by the dash-double dot line of FIG. 4. When ink droplets are ejected in this state, the ink droplets adhere to the rib 37b, thus causing contamination of the underside of a printing object 12 to be transported next over the rib 37b. Thereupon, when a transport amount sufficient for the 180th nozzle 63a to pass the straight line P is reached, the CPU 71 stops the driving of the piezoelectric elements via the head drive circuit 79 to end ejection of ink droplets (step S22). In this case, even if the print data remains, the remaining print data is cut off from being printed.

Additionally, the straight line P of FIG. 13 is spaced the distance S away from and parallel to the side edge portion 124, and the distance S is fixed even when the transport of the photo stand paper 120 proceeds. Besides, the driving up to the print end position is based on the reference point, but the transport amount from such a reference point to the print end position is pre-stored in the information storage means such as the ROM 72.

Besides, if it is determined in the step S21 that the photo stand paper 120 has not reached the prescribed print end position (if No is determined), the control returns to the step S15 to repeat the same step as aforesaid.

If No is determined in each step S14, S15, S17, or if the control passes through step S22, the DC unit 76 controls the PF motor 25 to discharge the photo stand paper 120 (step S23). In this case, the detection operation of the PW sensor 64 is stopped, and the PF motor 25 is driven at a predetermined rotation speed.

Once the control passes through each step, even when the so-called margin-less printing is performed on the print portion 121 of the photo stand paper 120 provided with the notches 123, ink droplets can be prevented from being ejected onto the rib 37b of the platen 36. This prevents ink droplets from adhering to the rib 37b, thus preventing contamination of the underside of a printing object 12 on which printing is to be executed next.

Besides, when the paper detector 35 does not pass over the photo stand paper 120, the rear end position of the photo stand paper 120 cannot be detected. Besides, even if the paper detector 35 passes over the photo stand paper 120, the rear end position of the photo stand paper 120 cannot be detected due to the existence of the notch 123b. However, in this embodiment, the position of the notches 123 and side edge portions 124 is recognized by moving the PW sensor 64 in the main scan direction while transporting the photo stand paper 120, and such a position is used as the reference point. Moreover, the transport amount up to the straight line P is pre-stored in the information storage means such as the ROM 72. Consequently, the margin-less printing can be reliably executed by only detection using the PW sensor 64, thus making it possible to resolve the problem of adhering ink droplets to the rib 37b, etc. due to unavailability of the paper detector 35.

Besides, in the control of the PF motor 25 of the first embodiment, when the PF roller pair 30 reaches the “kicking” control region, the rotation of the PF motor 25 decreases in speed. Here, when the PF drive roller 31 passes the top of the side edge portion 124 toward the paper discharge direction, the “kicking” force F directed toward the paper discharge direction is imparted to the side edge portion 124 of the photo stand paper 120. Thus, the photo stand paper 120 tends to rotate in the arrowed direction A as shown in FIG. 7.

However, the train of speed-up gears exists in the printer 10, and the drive control (hold current control) is exerted such that the rotation of the PF motor 25 decreases in speed when the PF roller pair 30 reaches the “kicking” control region. Consequently, the PF drive roller 31 can be restrained from increasing in rotation speed so as to resist the “kicking” force F. Therefore, the photo stand paper 120 can be restrained from rotating in the arrowed direction A as shown in FIG. 7.

Besides, as aforesaid, the transport error of the photo stand paper 120 can be corrected, and the photo stand paper 120 can be restrained from rotating in the arrowed direction A, thus making it possible to prevent a reduction in print quality of the print portion 121. That is, when the transport error is large, there occurs, for example, the problem in which a printed region has white stripes. And, when there occurs the rotation in the arrowed direction A of FIG. 7, this rotation causes a feed pitch to increase toward the side on which the side edge portion 124 exists. Thus, when printing is performed during this rotation, wider stripes toward the side edge portion 124 are formed. Besides, a portion to be printed after crossing the side edge portion 124 is placed in a slightly inclined state as compared with a portion that has been printed before crossing the side edge portion 124.

However, in the manner, the transport error can be corrected, and the photo stand paper 120 can be retrained from rotating in the arrowed direction A, so that print quality can be made satisfactory even in the case of using the photo stand paper 120.

Besides, the PW sensor 64 detects whether or not the photo stand paper 120 exists in the widthwise direction. Therefore, it is prevented that the paper detector 35 determines that no photo stand paper 120 exists. This can prevent that a gap adjusting mechanism malfunctions and the carriage 60 moves in a lowered position and thus that the printhead 62 hits the photo stand paper 120.

Besides, the PW sensor 64 is disposed on the carriage 60, so that the width of the photo stand paper 120 can be detected with the movement of the carriage 60. Furthermore, the PF motor 25, which is a DC motor, can be easily increased/reduced in drive torque. Besides, the driving is started with the side edge portion 124 as the reference point. Therefore, the notch 123a can be used as the reference of an amount of the photo stand paper 120 transported, thus making it possible to more reliably exert the drive control up to the switching point.

Furthermore, when the PF roller pair 30 passes the second switching point, the driving speed of the PF motor 25 can be increased. Therefore, the time before discharge can be reduced.

The first embodiment of the invention has so far been described, but may be modified in various ways. Such modified examples will be described below.

The first embodiment describes the case in which the printing object is the photo stand paper 120 having the notches 13 formed at both ends of one diagonal thereof. However, the configuration may be such that there is provided only one notch 123, or such that there are provided three notches 123 or more. Besides, the shape of the notch is not limited to a substantially square shape, but may be of any shape such as round. Furthermore, the first embodiment may be applied to a printing object having a notch other than the photo stand paper 120. Moreover, the guide member may use a member that supports transport of the printing object 12, other than the platen 62.

Besides, in the first embodiment, the ROM 72 has stored therein the transport amount responsive to the case in which the margin-less printing is performed on the photo stand paper 120. However, printing performed on the photo stand paper 120 is not limited to the margin-less printing. For example, normal printing having a smaller printing region than the print portion 121 may be performed on the photo stand paper 120. Besides, in the photo stand paper 120, the board portions 122 thereof may be printed. Additionally, to print the board portions 122, the configuration can be such as to switch the amount of movement in the main scan direction between the print portion 121 and the board portions 122.

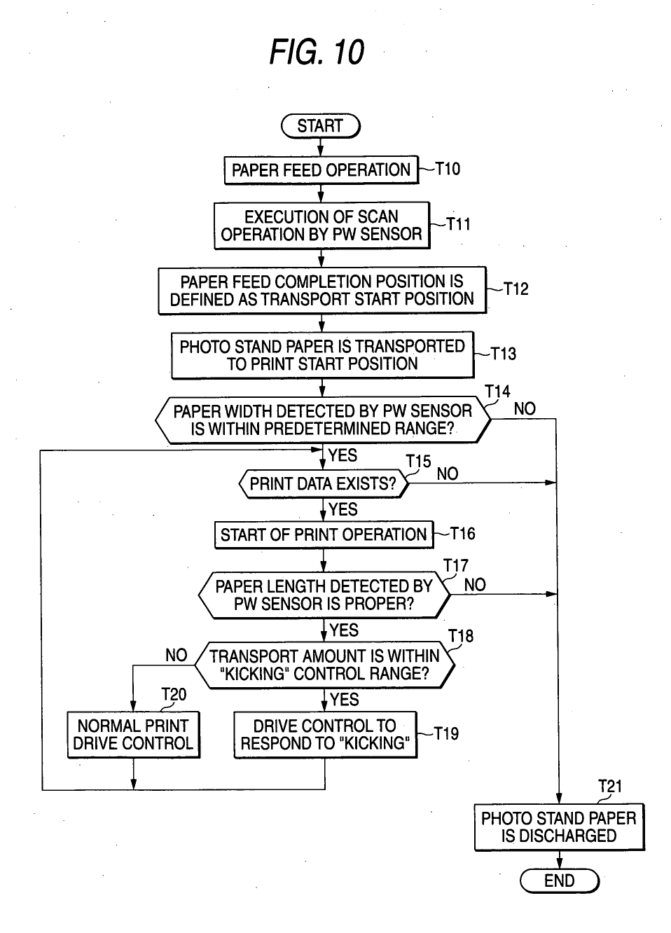

The second embodiment will now be described with reference to FIG. 10.

In the second embodiment, a drive control program responsive to the kind of the printing object 12 is stored in the ROM 72. This drive control program enables the control and driving of the PF motor 25 which are based on detection of the PW sensor 64 and correspond to a to-be-described flowchart shown in FIG. 10.

Step T10: When a user sets the photo stand paper 120 and sends a print command, a paper feed operation of feeding the photo stand paper 120 is started. In this case, the user inserts the photo stand paper 120, for example, from the opening 37. Then, by a transport operation of the PF motor 25, the photo stand paper 120 reaches the opening 37, and subsequently the front end thereof on the discharge side is nipped by the PF roller pair 30. And, the PF drive roller 31 is driven by the PF motor 25, thereby transporting the photo stand paper 120 toward the paper discharge side.

Besides, the CR motor 55 is also driven simultaneously with such a transport operation of the PF motor 25. And, the carriage 60 is driven in the main scan direction to cause the PW sensor 64 to execute a scan operation (see FIG. 7). A determination as to the presence/absence of the photo stand paper 120 and a recognition of the shape thereof are made through this scan operation. In this case, the PW sensor 64 performs the scan operation to the board portion 122 of the photo stand paper 120 which is positioned on the paper discharge side. Then, the notch 123a is also recognized at the same time, but cannot be recognized in this stage to be really the notch 123a (board portion 122).

Step T11: When the photo stand paper 120 is sequentially transported by the driving of the PF motor 25, a transition is made from the state in which the PW sensor 64 is opposite the board portion 122 to the state in which the PW sensor 64 is opposite the border portion between the board portion 122 and the print portion 121 (see FIGS. 7 and 8). Simultaneously, the PW sensor 64 is driven by the CR motor 55 to perform the scan operation. Then, the PW sensor 64 transmits to the CPU 71 a detection signal resulting from the difference in width between the board portion 122 and the print portion 121. Then, the CPU 71 recognizes that the paper feed is completed as the PW sensor 64 reaches the side edge portion 124. That is, the paper feed is completed to make the print portion 121 ready to be printed. Additionally, when the CPU 71 recognizes the difference in width as the PW sensor 64 reaches the side edge portion 124, this recognition point provides a transport reference point. However, the front side end of the photo stand paper 120 may be set as the reference point. Besides, when it is determined that the difference in width is recognized as the PW sensor 64 reaches the side edge portion 124, this determination corresponds to the reference point determination step. Additionally, the notch 123a is recognized from such a difference in width, whereby the kind of paper is determined to be the photo stand paper 120.

Step T12: The CPU 17 defines a paper feed completion position as a transport start position in the control and driving of the PF motor 25. That is, since paper detection by the paper detector 35 cannot be performed to the photo stand paper 120, the CPU 71, immediately after paper is fed, recognizes the paper as the photo stand paper 120 which is different from normal paper and switches its control to non-detection control of the paper detector 35. In this case, the amount of the photo stand paper 120 transported is counted based on and starting with the detection of the paper feed completion position by the PW sensor 64. Additionally, in this embodiment, the paper feed position is defined as the position at which the 180th nozzle 63a of the printhead 62 (the nozzle 63a closest to the paper feed side) substantially reaches the border line between the print portion 121 and the board portion 122. However, the paper feed completion position is not limited to this position, but may be modified in various ways.

Additionally, the non-detection control corresponds to the normal control region of FIG. 7.

Step T13: The photo stand paper 120 is transported from this paper feed completion position to a print start position. Here, the print start position is defined as the position at which the first nozzle 63a of the printhead 62 substantially reaches the border line. The drive control of the PF motor 25 in this case is also performed by counting the transport amount.

Step T14: Subsequently, the PW sensor 64 is used to determine a paper width. If, in this determination, the paper width does not match the paper width of a prescribed photo stand paper 120, the control proceeds to step T21. Besides, if the paper width matches the paper width of the prescribed photo stand paper 120, the control proceeds to the next step T15.

Step T15: If Yes is determined in step T14, or if the control passes through any one of steps T21 and T24, the CPU 71 determines whether or not print data exists in the RAM 73. If, in this determination, it is determined that the print data exists, the control proceeds to the next step T16. Besides, if it is determined that no print data exists, the control proceeds to step T21.

Step S16: If it is determined in step T15 that the print data exists, a print operation is started. This print operation is performed by driving the CR motor 55 to thereby move the carriage 60 in the main scan direction and also by controlling and driving the printhead 62. Additionally, the drive control of the PF motor 25 is exerted in either of to-be-described steps T19 or T20.

Step T17: The DC unit 76 uses the PW sensor 64 to determine the paper length of the photo stand paper 120. In this determination, the paper length is determined improper, for example, if the PW sensor 64 reaches the notch 123b before the amount of the photo stand paper 120 transported reaches a “kicking” control region, or if the notch 123b is not detected even after the transport amount passes the “kicking” control region. In this case, it is determined that the paper length does not match that of the prescribed photo stand paper 120, and the control proceeds to to-be-described step T21.

Step T18: The DC unit 76 determines whether or not the amount of the photo stand paper 120 transported has reached a switching point (reaches the “kicking” control region) (which corresponds to the transport amount determination step). This determination is made based on whether or not the amount transported by the PF motor 25 has reached the “kicking” control region. That is, the rotary encoder 81 is used to calculate the amount (speed) of rotation of the PF drive roller 31, thereby determining whether or not the amount of the photo stand paper 120 transported has reached a transport amount sufficient to reach a prescribed “kicking” control region. If, in this determination, it is determined that the amount of the photo stand paper 120 transported has reached the “kicking” control region, the control proceeds to the next step T19. Besides, if it is determined that the transport amount has not reached the “kicking” control region, the control proceeds to to-be-described step T20.

Step T19: If determining that the “kicking” control region is reached, the DC unit 76 controls the PF motor 25 so that the rotation speed of the PF motor 25 is reduced to drive the PF motor 25 by an amount equivalent to one step (which corresponds to the drive control step). That is, the DC unit 76 exerts control (hold current control) to make an applied voltage lower than that during printing and to reduce a current value as compared with that during printing. In this “kicking” control, when the PF roller pair 30 reaches the side edge portion 124, a “kicking” force F directed in the paper discharge direction is imparted by the spring 34 to the photo stand paper 120 (see FIG. 8). Consequently, the control (hold current control) is exerted over the FP motor 25 so that a current having a value capable of resisting such a “kicking” force F is allowed to flow through the PF motor 25. Here, the train of speed-up gears exists in the printer 10, and unless a high torque acts on a PF drive roller 31 side, it is difficult to rotate the PF motor 25 from the PF drive roller 31 side. Accordingly, the “kicking” force F can be resisted by only exerting the control to reduce the current value or by only imparting the PF motor 25 with a drive force to direct the printing object 12 slightly toward the paper feed side. Additionally, when the “kicking” control is driven in the printhead 62 by an amount equivalent to one line, the control subsequently returns to step T15 to repeat the operation.

Step T20: If it is determined in the step T18 that the transport amount has not reached the “kicking” control region, normal print drive control is exerted. In this normal print drive control, the rotation speed of the PF motor 25 is set to a rotation speed during normal printing (i.e., a higher rotation speed than that of step T19). In this case, the current value is made greater than in the step T19. After this print drive control in step T20 is exerted by an amount equivalent to one step (one line), the control returns to the step T15 to repeat the operation.

Additionally, the amount of drive corresponding to the “kicking” control region is pre-stored in the ROM 72. Besides, after the “kicking” control region is passed through, another region of control at a normal torque is reached, but a determination as to whether the control region is passed through or not is made based on whether the amount of drive pre-stored in the ROM 72 is reached or not. This amount of drive is an amount of drive before it is determined that the PF roller pair 30 has passed through a second switching point.

Step T21: If No is determined in steps T14, T15, and T17, the DC unit 76 controls the PF motor 25 to discharge the photo stand paper 120. In this case, the detection operation of the PW sensor 64 is stopped, and the PF motor 25 is driven at a predetermined rotation speed.

After the control passes through each step, when there exist an appropriate photo stand paper 120 and appropriate print data, printing is performed on the print portion 121, and when the “kicking” control region is reached, the rotation of the PF motor 25 decreases in speed and the rotation speed thereof is reduced. Here, when the PF roller pair 30 reaches the side edge portion 124 and the PF drive roller 31 passes the top of the side edge portion 124 toward the paper discharge direction, the “kicking” force F directed toward the paper discharge direction is imparted to only the side edge portion 124 out of the photo stand paper 120. Moreover, the border between the print portion 121 and the board portion 122 other than the side edge portion 124 is nipped by the PF roller pair 30. Therefore, when the PF roller pair 30 cannot resist the “kicking” force F and thus rotates easily, only the side edge portion 124 is first discharged, so that the photo stand paper 120 tends to rotate in the arrowed direction A as shown in FIG. 7.

However, the train of speed-up gears exists in the printer 10, and the drive control (hold current control) is exerted such that the rotation of the PF motor 25 decreases in speed when the PF roller pair 30 reaches the “kicking” control region. Consequently, the PF drive roller 31 can be restrained from increasing in rotation speed so as to resist the “kicking” force F. Therefore, the photo stand paper 120 can be restrained from rotating in the arrowed direction A as shown in FIG. 7.

Besides, as aforesaid, the photo stand paper 120 can be restrained from rotating in the arrowed direction A, thus making it possible to prevent a reduction in print quality of the print portion 121. That is, when there occurs the rotation in the arrowed direction A shown in FIG. 7, this rotation causes a feed pitch to increase toward the side on which the side edge portion 124 exists. Thus, during execution of printing on the print portion 121, a printed image is formed with wider stripes toward the side edge portion 124. Besides, a portion to be printed after crossing the side edge portion 124 is placed in a slightly inclined state as compared with a portion that has been printed before crossing the side edge portion 124.

However, if the photo stand paper 120 can be retrained in the manner from rotating in the arrowed direction A, it can be prevented that such stripes are formed and that the printed image is inclined from its middle portion. That is, print quality can be made satisfactory even in the case of using the photo stand paper 120.

Besides, the PW sensor 64 detects whether or not the photo stand paper 120 exists in the widthwise direction. Therefore, it is prevented that the paper detector 35 determines that no photo stand paper 120 exists. This can prevent that a gap adjusting mechanism malfunctions and the carriage 60 moves in a lowered position and thus that the printhead 62 hits the photo stand paper 120.

Besides, the PW sensor 64 is disposed on the carriage 60, so that the width of the photo stand paper 120 can be detected with the movement of the carriage 60. Furthermore, the PF motor 25, which is a DC motor, can be easily increased in drive torque by only reducing the current value. Besides, the driving is started with the side edge portion 124 as the reference point. Therefore, the notch 123a can be used as the reference of an amount of the photo stand paper 120 transported, thus making it possible to more reliably exert the drive control up to the switching point.

Besides, the paper discharge roller pair 40 is disposed in addition to the PF roller pair 30. Consequently, even after the rear end portion of the photo stand paper 120 passes the PF roller pair 30, the photo stand paper 120 is transported by the paper discharge roller pair 40. Therefore, printing can continue to be performed, thus making it possible to discharge the photo stand paper 120 after printing ends.

Furthermore, when the PF roller pair 30 passes the second switching point, the PF motor 25 increases in drive speed. Therefore, the time before discharge can be reduced.

The second embodiment of the invention has so far been described, but may be modified in various ways other than the aforesaid. Such modified examples will be described below.

The second embodiment describes the case in which the printing object is the photo stand paper 120 having the notches 123 formed at both ends of one diagonal thereof. However, the configuration may be such that there is provided only one notch 123, or such that there are provided three notches 123 or more. Besides, the shape of the notch is not limited to a substantially square shape, but may be of any shape such as round. Furthermore, the second embodiment may be applied to a printing object having a notch other than the photo stand paper 120.

Besides, in the second embodiment, the control is exerted to reduce the rotation speed of the PF motor 25 when the PF roller pair 30 reaches the “kicking” control region. However, the rotation speed of a PF motor may be increased if the PF motor can be imparted with a drive torque sufficient to resist the spring 34. Furthermore, regarding the “kicking”, the second embodiment may be applied to not only the case in which the spring 34 applies its force in the paper discharge direction but the case in which the spring 34 applies its force in the paper feed direction.

The third embodiment will now be described.

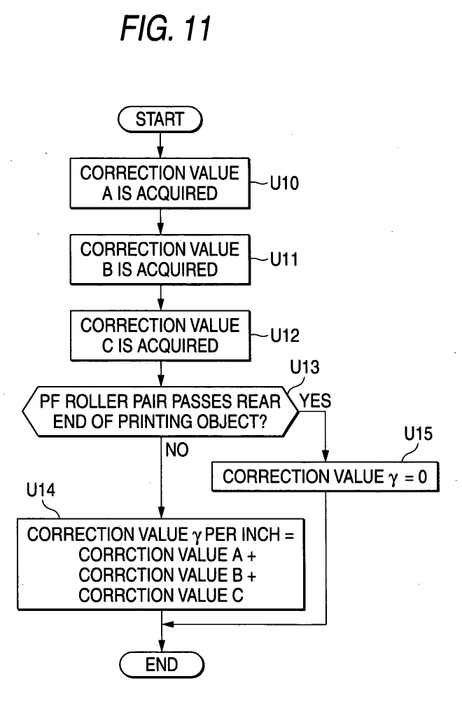

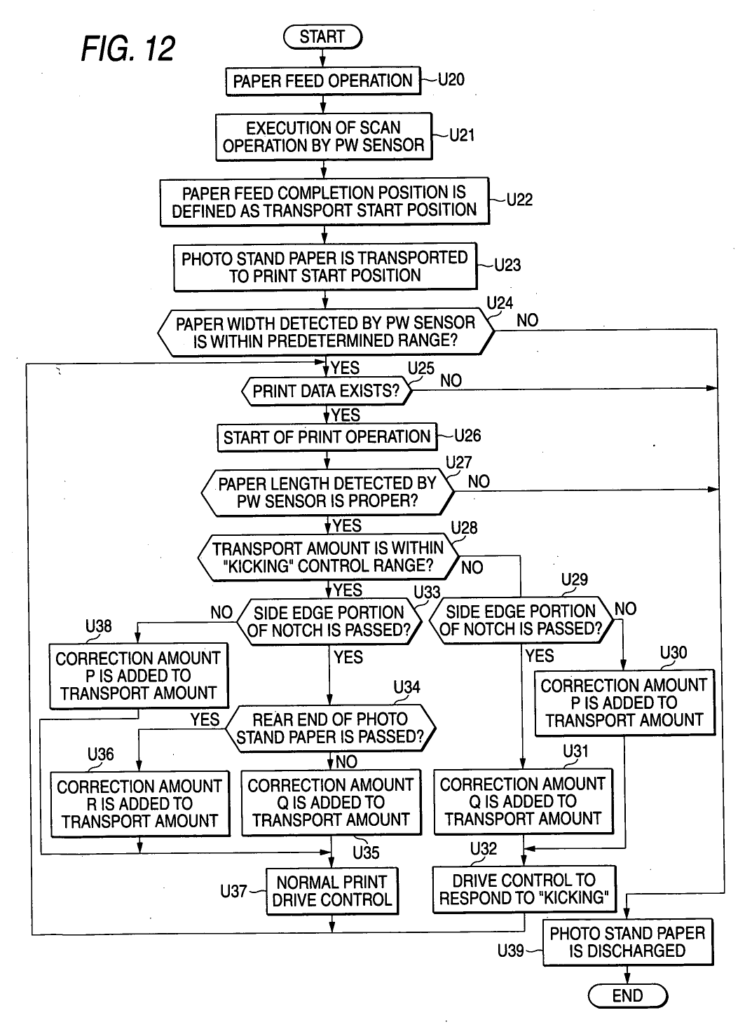

In a third embodiment, a drive control program, a correction value A, and the like responsive to the kind of the printing object 12 are stored in the ROM 72. This drive control program enables the control and driving of the PF motor 25 which are based on detection of the PW sensor 64 and correspond to to-be-described flowcharts shown in FIGS. 11 and 12.

There will first be described the method of correcting a general printing object other than the photo stand paper 120. To describe a correction value, the control section 70 corrects the amount of the printing object 12 transported, using three correction values A, B, and C serving as the correction information. These correction values are for correcting the error (hereinafter called the “transport error”) between a theoretical amount of the printing object 12 transported (paper transport amount) and an actual amount thereof transported.

The correction value A corresponding to the first correction value is for correcting a transport error caused by a mechanical variation (manufacturing error of the printer 10). The term mechanical variation refers mainly to the manufacturing error of the PF drive roller 31, including, for example, an outer diameter error, surface roughness (unevenness occurring on the surface), and the variation in distance between the platen surface of the platen 36 and the nozzle arrays 63 which is caused by an assembly error. This transport error has values that differ from one apparatus (printer 10) to another.

Such a transport error is obtained for each printer 10 before shipment, and furthermore, the correction value A is obtained from the transport error obtained and is written into the ROM 72 as an inherent value of each printer 10. Additionally, the data storage means into which the correction value A is written is not limited to the ROM 72, but may be the nonvolatile memory 80 or other data storage means.

Besides, the correction value B corresponding to the second correction value is for correcting a transport error that differs with each kind of paper or each region of transport of the printing object 12. The term transport error as used here refers mainly to a transport error caused by slippage of the printing object 12 at the PF roller pair 30. And, this transport error has values that differ with each kind of paper (however, sometimes has the same value for each kind of paper as a result), depending upon the friction force between the printing object 12 and the PF roller pair 30 (the width of the printing object 12 also has an influence as described later), the thickness of the printing object 12, the rigidity of the printing object 12, the size of the printing object 12, and the like. In the third embodiment, this transport error is pre-obtained for each printer 10, and furthermore, the correction value B is obtained for each kind of paper from the transport error obtained and is registered as an inherent value of each kind of paper into a printer driver operated on the computer 90 (see FIG. 3). Additionally, the configuration may be such that, similar to the correction value A, the correction value B is stored into the storage means such as the ROM 72 (see FIG. 5), and such that a correction value B suitable for a kind of paper designated by print data received is selected based on the kind of paper.

Next, the correction value C corresponding to the third correction value is for correcting a transport error that differs with each print resolution. The term transport error as used here refers mainly to a transport error caused by slippage of the printing object 12 at the PF roller pair 30, and this transport error has values that differ with each print resolution. More specifically, in the printer 10 of this embodiment, the amount and speed of single transport of the printing object 12 (which speed is the rotation speed of the PF drive roller 31) differ with each print resolution. Thereby, the transport error is made to differ with each print resolution, i.e., each condition of transport of the printing object 12.

In the third embodiment, such a transport error is pre-obtained for each print resolution, and furthermore, the correction value C is obtained from the transport error obtained and, similar to the correction value B, is registered as an inherent value of each print resolution into the printer driver operated on the host computer 90. Additionally, the configuration may be such that, similar to the correction value A, the correction value C is stored into the ROM 72, and such that a correction value C suitable for the kind of paper is selected based on a print resolution designated by the print data received.

FIG. 11 is a flowchart showing the flow (concept) of actually obtaining a correction value γ (per inch) of a transport amount. First, in step U10, the correction value A (which is a correction value for correcting the transport error caused by the manufacturing error) is acquired from the ROM 72. In step U11, the correction value B (which is a correction value for correcting the transport error that differs with each kind of paper) is acquired from the print data. And, in step U12, the correction value C (which is a correction value for correcting the transport error that differs with each kind of paper) is acquired from the print data.

Next, it is determined whether or not the rear end of the printing object 12 has passed through the PF roller pair 30. And, if the rear end of the printing object 12 has not passed through the PF roller pair 30 (if No), all the correction values A, B, and C are added together to obtain the correction value γ (step U13). Here, the configuration is such that the correction values A, B, and C have their references aligned with each other so as to become correction values to be all added to a transport amount 1 inch (target value), and such that the correction values A, B, and C can therefore be added to one another.

On the contrary, if the rear end of the printing object 12 has passed through the PF roller pair 30 (if Yes in step U13), the correction value γ is set to 0 (γ=0) (step U15). The reason is as follows. That is, in so-called four-side margin-less printing, the printing object 12 is transported by a transport force applied from the PF roller pair 30 until the rear end of the printing object 12 comes free from the PF roller pair. Additionally, on this occasion, the printing object 12 is subjected to a fixed transport force even from the paper discharge roller pair 40. However, the nip force of the PF roller pair 30 is extremely larger than that of the paper discharge roller pair 40, so that the printing object 12 is hardly affected by a transport force applied from the paper discharge roller pair 40.

On the other hand, when the rear end of the printing object 12 comes free from the PF roller pair 30, the printing object 12 is transported by only the transport force applied from the paper discharge roller 40. To describe more specifically, the PF drive roller 31 has a high-friction layer on the surface of a roller base made of metal, while the paper discharge drive roller 41 is made up of a rubber roller. Accordingly, it follows that the friction force between the printing object 12 and the PF drive roller 31 and the friction force between the printing object 12 and the paper discharge drive roller 41 are different from each other. Therefore, this provides a difference in transport error between when the printing object 12 is transported by the PF roller pair 31 and when the printing object 12 is transported by the paper discharge roller pair 40.

More specifically, the third embodiment is configured as follows. It is known that the amount of slippage of the printing object 12 at the PF drive roller 31 is larger than that at the paper discharge dive roller 41 made up of a rubber roller, and that the amount of slippage of the printing object at the paper discharge drive roller 41 can often be almost neglected in the printer 10 of this embodiment. Therefore, when such an amount of slippage can be thus neglected, the correction value γ is set to 0 (γ=0) after the rear end of the printing object 12 comes free from the transport roller pair 40, and thus no correction is made to the transport amount.

That is, in other words, the control section 70 has two correction values: correction value γ=correction value A+correction value B+correction value C; and correction value γ=0. The two correction values are for correcting the error between the actual transport amount obtained when the printing object 12 is transported by the PF roller pair 30 and the actual transport amount obtained when the printing object 12 is transported by the paper discharge roller pair 40. And, the control section 70 is configured to modify the correction value γ to be added to the amount of the printing object 12 transported, in response to a change in combination of the roller pairs 30 and 40 that impart a transport force to paper P. Therefore, this provides the following configuration. That is, even when there is a change in the combination of the roller pairs 30 and 40 that impart the transport force to the printing object 12, the amount of the printing object 12 transported can be always properly corrected by adopting a correction value suitable for the combination of the roller pairs 30 and 40 after such a change, so that high print quality can be obtained.

Additionally, there is a good likelihood that the same situation as the aforesaid in the PF roller pair 30, such as occurrence of the mechanical variation or the like, may arise even in the paper discharge roller pair 40. Therefore, the correction value γ is not limited to 0, but can have various values. Besides, in the third embodiment, there are provided two roller pairs 30 and 40 that impart the transport force to the printing object 12. However, even in a configuration such that there are provided three or more roller pairs that impart the transport force to the printing object 12 and such that a larger number of combinations of the roller pairs can be considered, when there is similarly a change in the combination of the roller pairs, the amount of the printing object 12 transported can be always properly corrected by providing a configuration such as to adopt a correction value suitable for the combination after such a change.

The aforesaid is the method of correcting the amount of the printing object 12 transported, using the general printing object 12 as the printing object 12. Subsequently, a correction method typical of using the photo stand paper 120 as the printing object 12 will be described with reference to FIG. 12.

First, when a user sets the photo stand paper 120 and sends a print start command, a paper feed operation of feeding the photo stand paper 120 is started. In this case, the user inserts the photo stand paper 120, for example, from the opening 37. Then, by a transport operation of the PF motor 25, the photo stand paper 120 reaches the opening 37, and subsequently the front end thereof on the discharge side is nipped by the PF roller pair 30. And, the PF drive roller 31 is driven by the PF motor 25, thereby transporting the photo stand paper 120 toward the paper discharge side.

Besides, the CR motor 55 is also driven simultaneously with such a transport operation of the PF motor 25. And, the carriage 60 is driven in the main scan direction to cause the PW sensor 64 to execute a scan operation (see FIG. 7). A determination as to the presence/absence of the photo stand paper 120 and a recognition of the shape thereof are made through this scan operation. In this case, the PW sensor 64 performs the scan operation to the board portion 122 of the photo stand paper 120 which is positioned on the paper discharge side. Then, the notch 123a is also recognized at the same time, but cannot be recognized in this stage to be really the notch 123a (board portion 122).

Subsequently, the PW sensor 64 executes the scan operation (step U21). That is, when the photo stand paper 120 is sequentially transported by the driving of the PF motor 25, a transition is made from the state in which the PW sensor 64 is opposite the board portion 122 to the state in which the PW sensor 64 is opposite the border portion between the board portion 122 and the print portion 121 (see FIGS. 7 and 8). Simultaneously, the PW sensor 64 is moved by the driving of the CR motor 55 to perform the scan operation. Then, the PW sensor 64 transmits to the CPU 71 a detection signal resulting from the difference in width between the board portion 122 and the print portion 121. The CPU 71 recognizes that the paper feed is completed as the PW sensor 64 reaches the side edge portion 124. That is, the paper feed is completed to make the print portion 121 ready to be printed. Additionally, when the CPU 71 recognizes the difference in width as the PW sensor 64 reaches the side edge portion 124, this recognition point provides a transport reference point. However, the front side end of the photo stand paper 120 may be set as the reference point. Besides, when it is determined that the difference in width is recognized as the PW sensor 64 reaches the side edge portion 124, this determination corresponds to the reference point determination step.

Next, in step U22, the CPU 17 defines a paper feed completion position as a transport start position in the control and driving of the PF motor 25. That is, since paper detection by the paper detector 35 cannot be performed to the photo stand paper 120, the CPU 71, immediately after paper is fed, recognizes the paper as the photo stand paper 120 which is different from normal paper and switches its control to non-detection control of the paper detector 35. In this case, the amount of the photo stand paper 120 transported is counted based on and starting with the detection of the paper feed completion position by the PW sensor 64. Additionally, in this embodiment, the paper feed position is defined as the position at which the 180th nozzle 63a of the printhead 62 (the nozzle 63a closest to the paper feed side) substantially reaches the border line between the print portion 121 and the board portion 122. However, the paper feed completion position is not limited to this position, but may be modified in various ways.

Additionally, the non-detection control corresponds to the normal control region of FIG. 7.

Next, the photo stand paper 120 is transported from this paper feed completion position to a print start position. Here, the print start position is defined as the position at which the first nozzle 63a of the printhead 62 substantially reaches the border line. The drive control of the PF motor 25 in this case is also performed by counting the transport amount. Besides, in step U24, the PW sensor 64 is used to determine a paper width. If, in this determination, the paper width does not match the paper width of a prescribed photo stand paper 120, the control proceeds to step U39. Besides, if the paper width matches the paper width of the prescribed photo stand paper 120, the control proceeds to the next step U25.

Subsequently, step U25 is executed. That is, if Yes is determined in step U24, or if the control passes through any one of steps U29 and U30, the CPU 71 determines whether or not print data exists in the RAM 73. If, in this determination, it is determined that the print data exists, the control proceeds to the next step U26. Besides, if it is determined that no print data exists, the control proceeds to step U39.

Next, if it is determined in step U25 that the print data exists, a print operation is started (step U26). This print operation is performed by driving the CR motor 55 to thereby move the carriage 60 in the main scan direction and also by controlling and driving the printhead 62. Additionally, the drive control of the PF motor 25 is exerted in either of to-be-described steps U32 or U37.

After step U26, the DC unit 76 uses the PW sensor 64 to determine the paper length of the photo stand paper 120 (step U27). In this determination, the paper length is determined improper, for example, if the PW sensor 64 reaches the notch 123a before the amount of the photo stand paper 120 transported reaches a “kicking” control region, or if the notch 123a is not detected even after the transport amount passes the “kicking” control region. In this case, it is determined that the paper length does not match that of the prescribed photo stand paper 120, and the control proceeds to to-be-described step U39.

If Yes is determined in step U27, the DC unit 76 determines whether or not the amount of the photo stand paper 120 transported has reached a switching point (has reached the “kicking” control region) (step U28). This determination is made based on whether or not the amount transported by the PF motor 25 has reached the “kicking” control region. That is, the rotary encoder 81 is used to calculate the amount (speed) of rotation of the PF drive roller 31, thereby determining whether or not the amount of the photo stand paper 120 transported has reached a transport amount sufficient to reach the “kicking” control region. If, in this determination, it is determined that the amount of the photo stand paper 120 transported has reached the “kicking” control region (if Yes), the control proceeds to the next step U29. Besides, if it is determined that the transport amount has not reached the “kicking” control region (if No), the control proceeds to to-be-described step U33.

If Yes is determined in step U28, it is determined whether or not the transport amount has passed the side edge portion 124 of the notch 123a (step U29). Such a determination is made to determine which of a correction amount P and a correction amount Q should be added. That is, if the PF roller pair 30 has not reached the notch 123b even in the “kicking” control region, the contact area between the PF roller pair 30 and the photo stand paper 120 is large, and therefore the friction force therebetween is also large, so that the DC unit 76 should add the correction amount P. However, if the PF roller pair 30 has reached the notch 123b in the “kicking” control region, the contact area between the PF roller pair 30 and the photo stand paper 120 is reduced by an amount equivalent to the notch 123b. Accordingly, if the PF roller pair 30 has reached the notch 123b, the DC unit 76 adds the correction amount Q.

There will now be described the correction amount Q (which corresponds to the notch side correction information), the correction amount P (which corresponds to the paper feed side correction information) in to-be-described step U30, and a correction amount R (which corresponds to the correction information and the paper discharge side correction information) in to-be-described step U36. The correction amounts P, Q, and R are basically equivalent to the correction value γ and are equivalent to a value obtained by adding all the correction values A, B, C together. Besides, the correction amount P, Q, and R are values for increasing/reducing the amount transported by the PF motor 22, and are values for increasing/reducing the drive time if the drive speed is constant. And now, the correction amount P is a correction amount mainly for transporting the print portion 121 before the PF roller pair 30 reaches the notch 123b. Besides, the correction amount Q is a correction amount that is added in place of the correction amount P when the board portion 122 is transported beyond the side edge portion 124 of the notch 123b. That is, the correction amount P and the correction amount Q have different values due to the difference in width of the photo stand paper 120 which results from the presence/absence of the notch 123b. Besides, the correction amount R is a correction amount that is added in place of the correction amount Q when the photo stand paper 120 is transported by only the paper discharge roller pair 40 beyond the position at which the PF roller pair 30 reaches the rear end of the photo stand paper 120.

Additionally, the correction values A, B, and C are provided in sets corresponding to the correction amounts P, Q, and R. Here, the correction value A corresponds to the mechanical variation of the PF roller pair 30 and paper discharge roller pair 40, and one kind of correction value exists for each roller pair, thus providing (Ap, Ap, Ae) for this group. Besides, since the correction value B is affected by the friction force involving the width of the photo stand paper 120, three values (Bp1, Bp2, Be) are provided in response to the correction amounts P, Q, and R. Besides, the correction value C is an inherent value of each print resolution, and one kind of correction value exists for each of the PF roller pair and the paper discharge roller pair 40, thus providing (Cp, Cp, Ce) for this group. Consequently, the correction amounts P, Q, and R can be obtained as the correction amount P=Ap+Bp1+Cp, the correction amount Q=Ap+Bp2+Cp, and the correction amount R=Ae+Be+Ce.

Additionally, the correction amounts P, Q, and R may be configured to be calculated each time by the CPU 71 and the DC unit 76. However, when all the correction values A, B, and C are pre-stored in the ROM 72, the correction amounts P, Q, and R may be configured to be pre-stored in the ROM 72.

Besides, if No is determined in step U29, the correction amount P is added (step U30), and if Yes is determined in step U29, the correction amount Q is added (step U31). And, since the transport amount is within the “kicking” control region in both these steps U30 and U31, the DC unit 76, with the correction amount P or Q added, controls the PF motor 25 so that the rotation speed of the PF motor 25 is reduced to drive the PF motor 25 by an amount equivalent to one step (step U32). That is, the DC unit 76 exerts control (hold current control) to make an applied voltage lower than that during printing and to reduce a current value as compared with that during printing.

In this “kicking” control, when the PF roller pair 30 reaches the side edge portion 124, a “kicking” force F directed in the paper discharge direction is imparted by the spring 34 to the photo stand paper 120 (see FIG. 8). Consequently, the control (hold current control) is exerted over the FP motor 25 so that a current having a value capable of resisting such a “kicking” force F is allowed to flow through the PF motor 25. Here, the train of speed-up gears exists in the printer 10, and unless a high torque acts on a PF drive roller 31 side, it is difficult to rotate the PF motor 25 from the PF drive roller 31 side. Accordingly, the “kicking” force F can be resisted by only exerting the control to reduce the current value or by only imparting the PF motor 25 with a drive force to direct the printing object 12 slightly toward the paper feed side. Additionally, when the “kicking” control is driven in the printhead 62 by an amount equivalent to one line, the control subsequently returns to step U25 to repeat the operation.

Besides, if it is determined in the step U28 that the transport amount has not reached the “kicking” control region (if No), it is subsequently determined whether or not the transport amount has passed the side edge portion 124 of the notch 123b (step U33). If Yes is determined in this determination, it is subsequently determined whether or not the PF roller pair 30 has passed the rear end of the photo stand paper 120 (step U34). This determination is made to determine which of the correction amount Q and the correction amount R should be added. That is, if the PF roller pair 30 has not passed the rear end of the photo stand paper 120 (if No), then similar to step U31, the DC unit 76 adds the correction amount Q (step U35). However, if the PF roller pair 30 has passed the rear end (if Yes), the photo stand paper 120 is hereafter transported by only the paper discharge roller pair 40, so that the DC unit 76 adds the correction amount R (step U36).

And, since the transport amount is not within the “kicking” control region in both steps U 35 and U36, normal print drive control is exerted to drive the PF motor 25 by an amount equivalent to one step (step U37). In this normal print drive control, the rotation speed of the PF motor 25 is set to a rotation speed during normal printing (i.e., a higher rotation speed than that of step U32). In this case, the current value is made greater than in the step U32. After this print drive control in step U37 is exerted by an amount equivalent to one step, the control returns to the step U25 to repeat the operation.

Besides, if it is determined in the step U33 that the transport amount has not passed the side edge portion 124 (if No), the DC unit 76 adds the correction amount P (step U38). After such a correction amount P is added, the control subsequently proceeds to the step U37.

Additionally, the amount of drive corresponding to the “kicking” control region and an amount of drive at a normal torque are pre-stored in the ROM 72. After the “kicking” control region is passed through as aforesaid, another region of control at the normal torque is reached, but a determination as to whether the control region is passed through or not is made based on whether the amount of drive pre-stored in the ROM 72 is reached or not. This amount of drive is an amount of drive before it is determined that the PF roller pair 30 has passed through a second switching point.

If No is determined in the steps U24, U25 and U27, the DC unit 76 controls the PF motor 25 to discharge the photo stand paper 120 (step U39). In this case, the detection operation of the PW sensor 64 is stopped, and the PF motor 25 is driven at a predetermined rotation speed.

When the control passes through each step, the rear end side of the amount of the photo stand paper 120 transported is predicted without using the paper detector 35, so that the correction amount can be switched from the correction amount Q to the correction amount R. Accordingly, the correction amount can be appropriately switched even with respect to the printing object 12 provided with the notches 123, such as the photo stand paper 120, thus making it possible to resolve the transport error.

Besides, in the third embodiment, the correction amount is switched from the correction amount P to the correction amount Q, not only when the PF roller pair 30 reaches the rear end side of the photo stand paper 120, but also when the PF roller pair 30 reaches the notch 123b of the photo stand paper 120. Therefore, there sometimes occurs the case in which the transport error differs due to the difference in friction force between the print portion 121 and the board portion 122. However, even in this case, the transport error can be more accurately corrected.

Besides, when the paper detector 35 does not pass over the photo stand paper 120, the rear end position of the photo stand paper 120 cannot be detected. Besides, even if the paper detector 35 passes over the photo stand paper 120, the rear end position of the photo stand paper 120 cannot be detected due to the existence of the notch 123b. However, in the third embodiment, the position of the notches 123 and side edge portions 124 is recognized by moving the PW sensor 64 in the main scan direction while transporting the photo stand paper 120. Therefore, the rear end position of the photo stand paper 120 and the position of the notch 123b can be accurately predicted, thus making it possible to resolve the problem in which the rear end position cannot be detected due to unavailability of the paper detector 35.

Besides, in the control of the PF motor 25 of the third embodiment, when the PF roller pair 30 reaches the “kicking” control region, the rotation of the PF motor 25 decreases in speed and the rotation speed thereof is reduced. Here, when the PF roller pair 30 reaches the side edge portion 124 and the PF drive roller 31 passes the top of the side edge portion 124 toward the paper discharge direction, the “kicking” force F directed toward the paper discharge direction is imparted to only the side edge portion 124 out of the photo stand paper 120. Moreover, the border between the print portion 121 and the board portion 122 other than the side edge portion 124 is nipped by the PF roller pair 30. Therefore, when the PF roller pair 30 cannot resist the “kicking” force F and thus rotates easily, only the side edge portion 124 is first discharged, so that the photo stand paper 120 tends to rotate in the arrowed direction A as shown in FIG. 7.

However, the train of speed-up gears exists in the printer 10, and the drive control (hold current control) is exerted such that the rotation of the PF motor 25 decreases in speed when the PF roller pair 30 reaches the “kicking” control region. Consequently, the PF drive roller 31 can be restrained from increasing in rotation speed so as to resist the “kicking” force F. Therefore, the photo stand paper 120 can be restrained from rotating in the arrowed direction A as shown in FIG. 7.

Besides, as aforesaid, the transport error of the photo stand paper 120 can be corrected, and the photo stand paper 120 can be restrained from rotating in the arrowed direction A, thus making it possible to prevent a reduction in print quality of the print portion 121. That is, when the transport error is large there occurs, for example, the problem in which a printed region has white stripes. And, when there occurs the rotation in the arrowed direction A of FIG. 7, this rotation causes a feed pitch to increase toward the side on which the side edge portion 124 exists. Thus, when printing is performed during this rotation, wider stripes toward the side edge portion 124 are formed. Besides, a portion to be printed after crossing the side edge portion 124 is placed in a slightly inclined state as compared with a portion that has been printed before crossing the side edge portion 124.

However, in the manner, the transport error can be corrected, and the photo stand paper 120 can be retrained from rotating in the arrowed direction A, so that print quality can be made satisfactory even in the case of using the photo stand paper 120.

Besides, the PW sensor 64 detects whether or not the photo stand paper 120 exists in the widthwise direction. Therefore, it is prevented that the paper detector 35 determines that no photo stand paper 120 exists. This can prevent that a gap adjusting mechanism malfunctions and the carriage 60 moves in a lowered position and thus that the printhead 62 hits the photo stand paper 120.

Besides, the PW sensor 64 is disposed on the carriage 60, so that the width of the photo stand paper 120 can be detected with the movement of the carriage 60. Furthermore, the PF motor 25, which is a DC motor, can be easily increased in drive torque by only reducing the current value. Besides, the driving is started with the side edge portion 124 as the reference point.

Therefore, the notch 123a can be used as the reference of an amount of the photo stand paper 120 transported, thus making it possible to more reliably exert the drive control up to the switching point.

Furthermore, when the PF roller pair 30 passes the second switching point, the PF motor 25 increases in drive speed. Thereby, the drive speed is increased to make it possible to reduce the time before discharge.

The third embodiment of the invention has so far been described, but may be modified in various ways other than the aforesaid. Such modified examples will be described below.

The third embodiment describes the case in which the printing object is the photo stand paper 120 having the notches 123 formed at both ends of one diagonal thereof. However, the configuration may be such that there is provided only one notch 123, or such that there are provided three notches 123 or more. Besides, the shape of the notch is not limited to a substantially square shape, but may be of any shape such as round. Furthermore, the third embodiment may be applied to a printing object having a notch other than the photo stand paper 120.

Besides, in the third embodiment, the correction amount is modified from P to Q when the PF roller pair 30 reaches the notch 123b, and the correction amount is modified from Q to R when the PF roller pair 30 reaches the rear end of the photo stand paper 120. However, the configuration may be such that the correction amount is held at P and not modified when the PF roller pair is positioned in the board portion 122. Furthermore, the configuration may be such that, when the PF roller pair 30 is positioned in the board portion 122 on the front side, a correction amount corresponding thereto is set to correct the driving information, thus resolving the transport error.

Besides, in the third embodiment, the control is exerted to reduce the rotation speed of the PF motor 25 when the PF roller pair 30 reaches the “kicking” control region. However, the rotation speed of a PF motor may be increased if the PF motor can be imparted with a drive torque sufficient to resist the spring 34. Furthermore, regarding the “kicking”, the third embodiment may be applied to not only the case in which the spring 34 applies its force in the paper discharge direction but the case in which the spring 34 applies its force in the paper feed direction.

What is claimed is:

1. A printing device having a first part and a second part and printing an image on a medium adapted to be transported from the first part to the second part in a transport direction and having a notch disposed at a back end portion in the transport direction, the printing device comprising:
a printing head disposed between the first part and the second part and adapted to eject ink to the medium;
a first driver operable to drive one of a pair of rollers adapted to nip the medium to form a nip portion therebetween so that the rollers transport the medium from the first part to the second part in the transport direction;
a second driver operable to drive the printing head so that the printing head ejects the ink to the medium;
an anticipator anticipating a location of the back end portion; and
a controller operable to control the second driver so as to cause the printing head not to eject the ink in association with the location anticipated by the anticipator.

2. A printing device having a first part and a second part and printing an image on a medium adapted to be transported from the first part to the second part in a transport direction and having a first notch disposed at a back end portion in the transport direction, the printing device comprising:
a guide member comprising:
a sliding portion adapted to be brought in contact with the medium and guiding the medium in the transport direction; and
a non-sliding portion including a concave portion;
a printing head disposed between the first part and the second part and having a ejecting element extending in the transport direction and adapted to cause the ejecting element to eject ink to the medium, a back section of the ejecting element without facing the sliding member;
a first driver operable to drive a pair of rollers adapted to nip the medium to form a nip portion therebetween so that the rollers transport the medium from the first part to the second part;
a second driver operable to drive the printing head so that the ejecting element ejects the ink to the medium;
a first acquirer operable to move in a widthwise direction perpendicular to the transport direction of the medium so as to acquire one of present information and absent information of the medium in the widthwise direction;
a fixer fixing a reference point at which the absent information turns to the present information;
a storage storing first predetermined drive-transport information for the first driver from a predetermined reference point corresponding to the reference point to the back end portion;
a second acquirer acquiring drive-transport information of the first driver in association with the present information;
a third acquirer acquiring first correspondence information between the nip portion and the back end portion in association with the drive-transport information and the first predetermined drive-transport information; and
a controller operable to control the second driver so as to cause the ejecting element not to eject the ink in association with the first correspondence information.

3. The printing device according to claim 2, wherein
the back end portion of the medium is interposed between the ejecting element and the sliding portion in an ink ejecting direction, and
the back section of the ejecting element faces the non-sliding portion in the ink ejecting direction.

4. The printing device according to claim 2, wherein
the back end portion of the medium is interposed between the ejecting element and the guide member in an ink ejecting direction.

5. The printing device according to claim 2, wherein
the medium has a second notch disposed at a front end portion in the transport direction and is diagonal to the first notch,
the storage stores second predetermined drive-transport information for the first driver from a predetermined reference point corresponding to the reference point to a first switching point disposed between the reference point and the first notch,
the third acquirer acquires second correspondence information between the nip portion and the first switching point in association with the drive-transport information and the second predetermined drive-transport information; and
the controller is operable to control the first driver in association with the second correspondence information so that first driving speed of the first driver before the first switching point corresponds to the nip portion is larger than second driving speed of the first driver after the first switching point corresponds to the nip portion.

6. The printing device according to claim 5, wherein
the storage stores third predetermined drive-transport information from a predetermined reference point corresponding to the reference point to a second switching point disposed between the first notch and a back edge portion of the medium in the transport direction,
the third acquirer acquires third correspondence information between the nip portion and the second switching point in association with the drive-transport information and the third predetermined drive-transport information; and
the controller is operable to control the first driver in association with the third correspondence information so that third driving speed of the first driver before the second switching point corresponds to the nip portion is smaller than fourth driving speed of the first driver after the second switching point corresponds to the nip portion.

7. The printing device according to claim 2 further comprising,
a carriage retaining the printing head and the first acquirer.

8. A control method of printing an image on a medium, transported from a first part to a second part in a transport direction and having a notch disposed at a back end portion in the transport direction, by a printing device comprising: a printing head disposed between the first part and the second part and having a ejecting element extending in the transport direction and adapted to cause the ejecting element to eject ink to the medium; a first driver operable to drive a pair of rollers adapted to nip the medium to form a nip portion therebetween so that the rollers transport the medium from the first part to the second part in the transport direction; a second driver operable to drive the printing head so that the ejecting element ejects the ink to the medium; and a storage storing predetermined drive-transport information for the first driver from a predetermined reference point to the back end portion, the control method comprising:
transporting the medium from the first part to the second part in the transporting direction;
acquiring one of present information and absent information of the medium in a widthwise direction perpendicular to the transport direction of the medium;
fixing a reference point at which the absent information turns to the present information, the reference point corresponding to the predetermined reference point;
acquiring drive-transport information of the first driver in association with the present information;
acquiring correspondence information between the nip portion and the back end portion in association with the drive-transport information and the predetermined drive-transport information; and
controlling the second driver so as to cause the ejecting element not to eject the ink in association with the correspondence information.

9. A printing device having a first part and a second part and printing an image on a medium adapted to be transported from the first part to the second part in a transport direction and having a notch, the printing device comprising:
a printing head disposed between the first part and the second part and adapted to eject ink to the medium;
a pair of rollers adapted to nip the medium to form a nip portion therebetween, at least one of the pair of rollers linked to an elastic member and urged to face each of the rollers by the elastic member;
a driver operable to drive one of the pair of rollers so that the pair of rollers transport the medium from the first part to the second part in the transport direction;
an anticipator anticipating a location of the notch; and
a controller operable to control the driver so as to the one of the pair of rollers cause to resist being urged by the elastic member almost when the notch corresponds to the nip portion in association with the location anticipated by the anticipator.

10. A printing device having a first part and a second part and printing an image on a medium adapted to be transported from the first part to the second part in a transport direction and having a first notch disposed at a back portion and a second notch disposed at a front portion in the transport direction, the printing device comprising:
a printing head disposed between the first part and the second part and adapted to eject ink to the medium;
a first pair of rollers adapted to nip the medium to form a nip portion therebetween;
a driver operable to drive one of the first pair of rollers so that the first pair of rollers transport the medium from the first part to the second part in the transport direction;
a first acquirer disposed between the second part and the first pair of the rollers and operable to move in a widthwise direction perpendicular to the transport direction of the medium so as to acquire one of present information and absent information of the medium in the widthwise direction;
a fixer fixing a reference point at which the absent information turns to the present information;
a storage storing first predetermined drive-transport information for the driver from a predetermined reference point corresponding to the reference point to a first switching point disposed between the front portion and the first notch;
a second acquirer acquiring drive-transport information of the driver in association with the present information;
a third acquirer acquiring first correspondence information between the nip portion and the first switching point in association with the drive-transport information and the first predetermined drive-transport information; and
a controller operable to control the driver in association with the first correspondence information so that first driving speed of the driver before the first switching point corresponds to the nip portion is larger than second driving speed of the driver after the first switching point corresponds to the nip portion.

11. The printing device according to claim 10, wherein
at least one of the first pair of rollers are linked to an elastic member and urged to face each of the rollers by the elastic member, and
the controller controls the second speed so that the one of the first pair of rollers resist being urged by the elastic member.

12. The printing device according to claim 10, wherein
the driver includes a DC motor.

13. The printing device according to claim 10 further comprising,
a carriage retaining the printing head and the first acquirer.

14. The printing device according to claim 10, wherein
the medium comprises the front portion, the back portion and a print portion arranged between the front portion and the back portion,
the second notch is brought contact with the print portion at a boundary portion disposed between the print portion and the back portion, and
the first acquirer acquires the present information at the boundary portion.

15. The printing device according to claim 10 further comprising,
a second pair of rollers is disposed between the second part and the first acquirer and is adapted to transport the medium to the second part.

16. The printing device according to claim 10, wherein
the second notch and the first notch are diagonally disposed at opposite ends of the medium in the transport direction.

17. The printing device according to claim 10, wherein
the medium comprises the front portion, the back portion and a print portion arranged between the front portion and the back portion,
the second notch is brought contact with the print portion at a boundary portion disposed between the print portion and the back portion,
the printing head has a ejecting element extending in the transport direction and is adapted to cause the ejecting element to eject the ink to the medium,
the storage stores second predetermined drive-transport information for the driver from a predetermined reference point corresponding to the reference point to the boundary portion, and
the third acquirer acquires second correspondence information between a back end portion of the ejecting element in the transport direction and the boundary portion in association with the drive-transport information and the second predetermined drive-transport information.

18. The printing device according to claim 10, wherein
the medium comprises the front portion, the back portion and a print portion arranged between the front portion and the back portion,
the first notch is brought contact with the print portion at a boundary portion disposed between the print portion and the back portion,
the storage stores second predetermined drive-transport information for the driver from the first switching point to a second switching point disposed between the boundary portion and a back edge portion of the medium in the transport direction;
the third acquirer acquires second correspondence information between the second nip portion and the nip portion in association with the drive-transport information and the second predetermined drive-transport information; and
the controller is operable to control the driver so that third driving speed of the driver after the second switching point corresponds to the nip portion is larger than fourth driving speed of the driver after the second switching point corresponds to the nip portion.

19. A method of controlling a driver operable to drive a first roller adapted to nip a medium, having a first notch disposed at a back portion and a second notch disposed at a front portion in the transport direction, together with a second roller to form a nip portion and operable to transport the medium together with the second roller from a first part to a second part in the transport direction in a printing device that prints an image on the medium and stores predetermined drive-transport information for the driver from a predetermined reference point to a switching point disposed between the front portion and the first notch, the method comprising:
transporting the medium from the first part to the second part in the transport direction;
acquiring one of present information and absent information of the medium in a widthwise direction perpendicular to the transport direction of the medium;
fixing a reference point at which the absent information turns to the present information, the reference point corresponding to the predetermined reference point;
acquiring drive-transport information of the driver in association with the present information,
acquiring correspondence information between the nip portion and the switching point in association with the drive-transport information and the predetermined drive-transport information, and
controlling the driver in association with the correspondence information so that first driving speed of the driver before the switching point corresponds to the nip portion is larger than second driving speed of the driver after the switching point corresponds to the nip portion.

20. A printing device having a first part and a second part and printing an image on a medium adapted to be transported from the first part to the second part in a transport direction and having a notch, the printing device comprising:
a printing head disposed between the first part and the second part and adapted to eject ink to the medium;
a first pair of rollers adapted to nip the medium to form a nip portion therebetween;
a second pair of rollers disposed between the second part and the first pair of rollers and adapted to nip the medium;
a driver operable to drive one of the first pair of rollers and one of the second pair of rollers in association with driving information so that the first pair of rollers and the second pair of rollers transport the medium from the first part to the second part in the transport direction;
an anticipator anticipating a location of one of the notch and a back end portion of the medium in the transport direction;
a storage storing at least two correction information related to the driving information; and
a controller operable to control the driver so as to correct the driving information by first one of the correction information before the one of the notch and the back end portion corresponds to the nip portion and so as to correct the driving information by second one of the correction information after the one of the notch and the back end portion corresponds to the nip portion in association with the location anticipated by the anticipator.

21. A printing device having a first part and a second part and printing an image on a medium having a notch and adapted to be transported from the first part to the second part in a transport direction, the printing device comprising:
a printing head disposed between the first part and the second part and adapted to eject ink to the medium;
a first pair of rollers adapted to nip the medium to form a nip portion therebetween;
a second pair of rollers disposed between the second part and the first pair of rollers and adapted to nip the medium;
a driver operable to drive one of the first pair of rollers and one of the second pair of rollers in association with driving information so that the first pair of rollers and the second pair of rollers transport the medium from the first part to the second part in the transport direction;
a first storage storing the driving information and at least two correction information related to the driving information;
a first acquirer disposed between the second part and the first pair of the rollers and operable to move in a widthwise direction perpendicular to the transport direction of the medium so as to acquire present information and absent information of the medium in the widthwise direction;
a fixer fixing a reference point at which the absent information turns to the present information;
a second storage storing first predetermined drive-transport information for the driver from a predetermined reference point corresponding to the reference point to a back end portion of the medium in the transport direction;
a second acquirer acquiring drive-transport information of the driver in association with the present information;
a third acquirer acquiring first correspondence information between the nip portion and the back end portion in association with the drive-transport information and the first predetermined drive-transport information; and
a controller operable to control the driver so as to correct the driving information by first one of the correction information before the back end portion corresponds to the nip portion and so as to correct the driving information by second one of the correction information after the back end portion corresponds to the nip portion in association with the first correspondence information.

22. The printing device according to claim 21, wherein
the first storage stores first correction information related to the driving information,
the second storage stores second predetermined drive-transport information for the driver from a predetermined reference point corresponding to the reference point to the notch;
the third acquirer acquires second correspondence information between the nip portion and the notch in association with the drive-transport information and the second predetermined drive-transport information, and
the controller is operable to control the driver so as to correct the driving information by the first correction information after the notch corresponds to the nip portion in association with the second correspondence information.

23. The printing device according to claim 22, wherein
the at least two correction information include second correction information and third correction information,
the controller is operable to control the driver so as to correct the driving information by the second correction information before the notch corresponds to the nip portion in association with the second correspondence information, and
the controller is operable to control the driver so as to correct the driving information by the third correction information after the back end portion corresponds to the nip portion in association with the first correspondence information.

24. The printing device according to claim 21, wherein
the correction information includes a first correction value related to a manufacturing error of the printing device, a second correction value related to one of the medium and a part of the printing device and a third correction value related to print resolution of the printing device.

25. The printing device according to claim 21, wherein
the notch includes a first notch disposed at the back end portion of the medium and a second notch disposed at a front end portion of the medium in the transport direction and being diagonal to the first notch,
the second storage stores second predetermined drive-transport information for the driver from a predetermined reference point corresponding to the reference point to a first switching point disposed between the first notch and a front edge portion of the medium in the transport direction,
the third acquirer acquires second correspondence information between the nip portion and the first switching point in association with the drive-transport information and the second predetermined drive-transport information, and
the controller is operable to control the driver in association with the second correspondence information so that first driving speed of the driver before the first switching point corresponds to the nip portion is larger than second driving speed of the driver after the first switching point corresponds to the nip portion.

26. The printing device according to claim 25, wherein
the second storage stores third predetermined drive-transport information for the driver from a predetermined reference point corresponding to the reference point to a second switching point disposed between the first notch and a back edge portion of the medium in the transport direction,
the third acquirer acquires third correspondence information between the nip portion and the second switching point in association with the drive-transport information and the third predetermined drive-transport information, and
the controller is operable to control the driver in association with the third correspondence information so that third driving speed of the driver before the second switching point corresponds to the nip portion is smaller than fourth driving speed of the driver after the second switching point corresponds to the nip portion.

27. The printing device according to claim 25, wherein
the driver includes a DC motor.

28. The printing device according to claim 21 further comprising,
a carriage retaining the printing head and the first acquirer.

29. A method of controlling a driver operable to drive a first roller in association with driving information, the first roller adapted to nip a medium having a notch together with a second roller to form a nip portion and operable to transport the medium together with the second roller from a first part to a second part in a transport direction in a printing device that prints an image on the medium and stores a first correction information related to the driving information, a second correction information related to the driving information and predetermined drive-transport information for the driver from a predetermined reference point to a back end portion of the medium in the transport direction, the method comprising:
transporting the medium from the first part to the second part in the transport direction;
acquiring one of present information and absent information of the medium in a widthwise direction perpendicular to the transport direction of the medium;
fixing a reference point at which the absent information turns to the present information, the reference point corresponding to the predetermined reference point;
correcting the driving information by the first correction information in association with the reference point;
acquiring drive-transport information of the driver in association with the present information;
acquiring correspondence information between the nip portion and the back end portion in association with the drive-transport information and the predetermined drive-transport information;
correcting the driving information by the second correction information in association with the correspondence information; and
controlling the driver in association with the driving information corrected by the second correction information.
